(19) United States
(12) Patent Application Publication
(10) Pub. No.: US 2023/0007305 A1
(43) Pub. Date: Jan. 5, 2023

(54) SUBPICTURE PARTITIONING AND SCALING WINDOW INFORMATION

(71) Applicant: Tencent America LLC, Palo Alto, CA (US)

(72) Inventors: Byeongdoo CHOI, Palo Alto, CA (US); Stephan WENGER, Hillsborough, CA (US); Xiang LI, Saratoga, CA (US); Shan LIU, San Jose, CA (US)

(73) Assignee: Tencent America LLC, Palo Alto, CA (US)

(21) Appl. No.: 17/850,608

(22) Filed: Jun. 27, 2022

Related U.S. Application Data
(60) Provisional application No. 63/215,937, filed on Jun. 28, 2021.

(51) Int. Cl. H04N 19/70; H04N 19/44; H04N 19/172; H04N 19/167; H04N 19/119; H04N 19/30

(52) U.S. Cl. CPC H04N 19/70; H04N 19/44; H04N 19/172; H04N 19/167; H04N 19/119; H04N 19/30

(57) ABSTRACT

Aspects of the disclosure provide a method, an apparatus, and non-transitory computer-readable storage medium for video decoding. The apparatus includes processing circuitry configured to decode at least one of a first flag or a second flag in a syntax structure for a first picture in a coded video sequence (CVS). The first flag can indicate whether first subpicture partitioning information of the first picture is signaled in the syntax structure. The second flag can indicate whether first subpicture scaling window information for a first subpicture included in the first picture is signaled in the syntax structure. The processing circuitry reconstructs the first subpicture based on the at least one of the first flag indicating that the first subpicture partitioning information of the first picture is signaled in the syntax structure or the second flag indicating that the first subpicture scaling window information for the first subpicture is signaled in the syntax structure.

### INCORPORATION BY REFERENCE

This present disclosure claims the benefit of priority to U.S. Provisional Application No. 63/215,937, “Techniques for subpicture-wise reference picture resampling and scalability for video streaming” filed on Jun. 28, 2021, which is incorporated by reference herein in its entirety.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image and/or video coding and decoding can be performed using inter-picture prediction with motion compensation. Uncompressed digital image and/or video can include a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed image and/or video has specific bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GBytes of storage space.

One purpose of image and/or video coding and decoding can be the reduction of redundancy in the input image and/or video signal, through compression. Compression can help reduce the aforementioned bandwidth and/or storage space requirements, in some cases by two orders of magnitude or more. Although the descriptions herein use video encoding/decoding as illustrative examples, the same techniques can be applied to image encoding/decoding in similar fashion without departing from the spirit of the present disclosure. Both lossless compression and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signals is small enough to make the reconstructed signal useful for the intended application. In the case of video, lossy compression is widely employed. The amount of distortion tolerated depends on the application; for example, users of certain consumer streaming applications may tolerate higher distortion than users of television distribution applications. The compression ratio achievable can reflect that: higher allowable/tolerable distortion can yield higher compression ratios.

A video encoder and decoder can utilize techniques from several broad categories, including, for example, motion compensation, transform, quantization, and entropy coding.

Video codec technologies can include techniques known as intra coding. In intra coding, sample values are represented without reference to samples or other data from previously reconstructed reference pictures. In some video codecs, the picture is spatially subdivided into blocks of samples. When all blocks of samples are coded in intra mode, that picture can be an intra picture. Intra pictures and their derivations such as independent decoder refresh pictures, can be used to reset the decoder state and can, therefore, be used as the first picture in a coded video bitstream and a video session, or as a still image. The samples of an intra block can be exposed to a transform, and the transform coefficients can be quantized before entropy coding. Intra prediction can be a technique that minimizes sample values in the pre-transform domain. In some cases, the smaller the DC value after a transform is, and the smaller the AC coefficients are, the fewer the bits that are required at a given quantization step size to represent the block after entropy coding.

Traditional intra coding such as known from, for example MPEG-2 generation coding technologies, does not use intra prediction. However, some newer video compression technologies include techniques that attempt, from, for example, surrounding sample data and/or metadata obtained during the encoding and/or decoding of spatially neighboring, and preceding in decoding order, blocks of data. Such techniques are henceforth called “intra prediction” techniques. Note that in at least some cases, intra prediction is using reference data only from the current picture under reconstruction and not from reference pictures.

There can be many different forms of intra prediction. When more than one of such techniques can be used in a given video coding technology, the technique in use can be coded in an intra prediction mode. In certain cases, modes can have submodes and/or parameters, and those can be coded individually or included in the mode codeword. Which codeword to use for a given mode, submode, and/or parameter combination can have an impact in the coding efficiency gain through intra prediction, and so can the entropy coding technology used to translate the codewords into a bitstream.

A certain mode of intra prediction was introduced with H.264, refined in H.265, and further refined in newer coding technologies such as joint exploration model (JEM), versatile video coding (VVC), and benchmark set (BMS). A predictor block can be formed using neighboring sample values belonging to already available samples. Sample values of neighboring samples are copied into the predictor block according to a direction. A reference to the direction in use can be coded in the bitstream or may itself be predicted.

Referring to FIG. 1A, depicted in the lower right is a subset of nine predictor directions known from H.265's 33 possible predictor directions (corresponding to the 33 angular modes of the 35 intra modes). The point where the arrows converge (101) represents the sample being predicted. The arrows represent the direction from which the sample is being predicted. For example, arrow (102) indicates that sample (101) is predicted from a sample or samples to the upper right, at a 45 degree angle from the horizontal. Similarly, arrow (103) indicates that sample (101) is predicted from a sample or samples to the lower left of sample (101), in a 22.5 degree angle from the horizontal.

Still referring to FIG. 1A, on the top left there is depicted a square block (104) of 4×4 samples (indicated by a dashed, boldface line). The square block (104) includes 16 samples, each labelled with an “S”, its position in the Y dimension (e.g., row index) and its position in the X dimension (e.g., column index). For example, sample S21 is the second sample in the Y dimension (from the top) and the first (from the left) sample in the X dimension. Similarly, sample S44 is the fourth sample in block (104) in both the Y and X dimensions. As the block is 4×4 samples in size, S44 is at the bottom right. Further shown are reference samples that follow a similar numbering scheme. A reference sample is labelled with an R, its Y position (e.g., row index) and X position (column index) relative to block (104). In both H.264 and H.265, prediction samples neighbor the block under reconstruction; therefore no negative values need to be used.

Intra picture prediction can work by copying reference sample values from the neighboring samples as appropriated by the signaled prediction direction. For example, assume the coded video bitstream includes signaling that, for this block, indicates a prediction direction consistent with arrow (102)—that is, samples are predicted from a prediction sample or samples to the upper right, at a 45 degree angle from the horizontal. In that case, samples S41, S32, S23, and S14 are predicted from the same reference sample R05. Sample S44 is then predicted from reference sample R08.

In certain cases, the values of multiple reference samples may be combined, for example through interpolation, in order to calculate a reference sample; especially when the directions are not evenly divisible by 45 degrees.

The number of possible directions has increased as video coding technology has developed. In H.264 (year 2003), nine different direction could be represented. That increased to 33 in H.265 (year 2013), and JEM/VVC/BMS, at the time of disclosure, can support up to 65 directions. Experiments have been conducted to identify the most likely directions, and certain techniques in the entropy coding are used to represent those likely directions in a small number of bits, accepting a certain penalty for less likely directions. Further, the directions themselves can sometimes be predicted from neighboring directions used in neighboring, already decoded, blocks.

FIG. 1B shows a schematic (110) that depicts 65 intra prediction directions according to JEM to illustrate the increasing number of prediction directions over time.

The mapping of intra prediction directions bits in the coded video bitstream that represent the direction can be different from video coding technology to video coding technology; and can range, for example, from simple direct mappings of prediction direction to intra prediction mode, to codewords, to complex adaptive schemes involving most probable modes, and similar techniques. In all cases, however, there can be certain directions that are statistically less likely to occur in video content than certain other directions. As the goal of video compression is the reduction of redundancy, those less likely directions will, in a well working video coding technology, be represented by a larger number of bits than more likely directions.

Motion compensation can be a lossy compression technique and can relate to techniques where a block of sample data from a previously reconstructed picture or part thereof (reference picture), after being spatially shifted in a direction indicated by a motion vector (MV henceforth), is used for the prediction of a newly reconstructed picture or picture part. In some cases, the reference picture can be the same as the picture currently under reconstruction. MVs can have two dimensions X and Y, or three dimensions, the third being an indication of the reference picture in use (the latter, indirectly, can be a time dimension).

In some video compression techniques, an MV applicable to a certain area of sample data can be predicted from other MVs, for example from those related to another area of sample data spatially adjacent to the area under reconstruction, and preceding that MV in decoding order. Doing so can substantially reduce the amount of data required for coding the MV, thereby removing redundancy and increasing compression. MV prediction can work effectively, for example, because when coding an input video signal derived from a camera (known as natural video) there is a statistical likelihood that areas larger than the area to which a single MV is applicable move in a similar direction and, therefore, can in some cases be predicted using a similar motion vector derived from MVs of neighboring area. That results in the MV found for a given area to be similar or the same as the MV predicted from the surrounding MVs, and that in turn can be represented, after entropy coding, in a smaller number of bits than what would be used if coding the MV directly. In some cases, MV prediction can be an example of lossless compression of a signal (namely: the MVs) derived from the original signal (namely: the sample stream). In other cases, MV prediction itself can be lossy, for example because of rounding errors when calculating a predictor from several surrounding MVs.

Various MV prediction mechanisms are described in H.265/HEVC (ITU-T Rec. H.265, “High Efficiency Video Coding”, December 2016). Out of the many MV prediction mechanisms that H.265 offers, described here is a technique henceforth referred to as “spatial merge”.

Referring to FIG. 2, a current block (201) comprises samples that have been found by the encoder during the motion search process to be predictable from a previous block of the same size that has been spatially shifted. Instead of coding that MV directly, the MV can be derived from metadata associated with one or more reference pictures, for example from the most recent (in decoding order) reference picture, using the MV associated with either one of five surrounding samples, denoted A0, A1, and B0, B1, B2 (202 through 206, respectively). In H.265, the MV prediction can use predictors from the same reference picture that the neighboring block is using.

### SUMMARY

Aspects of the disclosure provide methods and apparatuses for video encoding and decoding. In some examples, an apparatus for video decoding includes processing circuitry. The processing circuitry is configured to decode at least one of a first flag or a second flag in a syntax structure for a first picture in a coded video sequence (CVS). The first picture includes a first subpicture. The first flag can indicate whether first subpicture partitioning information of the first picture is signaled in the syntax structure. The second flag can indicate whether first subpicture scaling window information for the first subpicture is signaled in the syntax structure. The processing circuitry can reconstruct the first subpicture based on the at least one of the first flag indicating that the first subpicture partitioning information of the first picture is signaled in the syntax structure or the second flag indicating that the first subpicture scaling window information for the first subpicture is signaled in the syntax structure.

In an embodiment, the syntax structure is a first picture parameter set (PPS) syntax structure.

In an embodiment, the at least one of the first flag and the second flag includes the first flag. The first flag indicates that the first subpicture partitioning information for the first picture is signaled in the syntax structure.

In an embodiment, the first picture includes a plurality of subpictures, the plurality of subpictures including the first subpicture. The processing circuitry can determine, based on the first subpicture partitioning information, a first subpicture layout of the plurality of subpictures in the first picture including a size and a position of each of the plurality of subpictures in the first picture.

In an embodiment, a subpicture identifier (ID) of each subpicture in the first picture can be determined based on the first subpicture partitioning information in the syntax structure.

In an embodiment, the syntax structure is a first picture parameter set (PPS) syntax structure. The processing circuitry can decode second subpicture partitioning information signaled in a second PPS syntax structure for a second picture in the CVS. The processing circuitry can reconstruct second subpictures in the second picture based on the second subpicture partitioning information. A second subpicture layout of the second picture can be different from the first subpicture layout of the first picture.

In an embodiment, the first picture is in a first layer in the CVS. The processing circuitry can decode second subpicture partitioning information signaled in another syntax structure for a second picture in a second layer in the CVS. The second subpicture partitioning information can be different from the first subpicture partitioning information. The processing circuitry can reconstruct second subpictures in the second picture based on the second subpicture partitioning information.

In an embodiment, the at least one of the first flag and the second flag includes the second flag, and the second flag indicates that the first subpicture scaling window information of the first subpicture is signaled in the syntax structure.

In an embodiment, the processing circuitry decodes the first subpicture scaling window information of the first subpicture based on the syntax structure. The processing circuitry can reconstruct the first subpicture using subpicture-wise reference picture resampling that is based on the first subpicture scaling window information of the first subpicture.

In an embodiment, the at least one of the first flag and the second flag further includes the first flag. The first flag indicates that the first subpicture partitioning information is signaled in the syntax structure. The processing circuitry can decode the first subpicture scaling window information of the first subpicture based on the syntax structure. The processing circuitry can determine dimension information and position information of the first subpicture based on the first subpicture partitioning information. The processing circuitry can reconstruct the first subpicture based on the first subpicture scaling window information of the first subpicture, the dimension information of the first subpicture, and the position information of the first subpicture.

Aspects of the disclosure also provide a non-transitory computer-readable storage medium storing a program executable by at least one processor to perform the methods for video decoding.

### BRIEF DESCRIPTION OF THE DRAWINGS

Further features, the nature, and various advantages of the disclosed subject matter will be more apparent from the following detailed description and the accompanying drawings in which:

FIG. 1A is a schematic illustration of an exemplary subset of intra prediction modes.

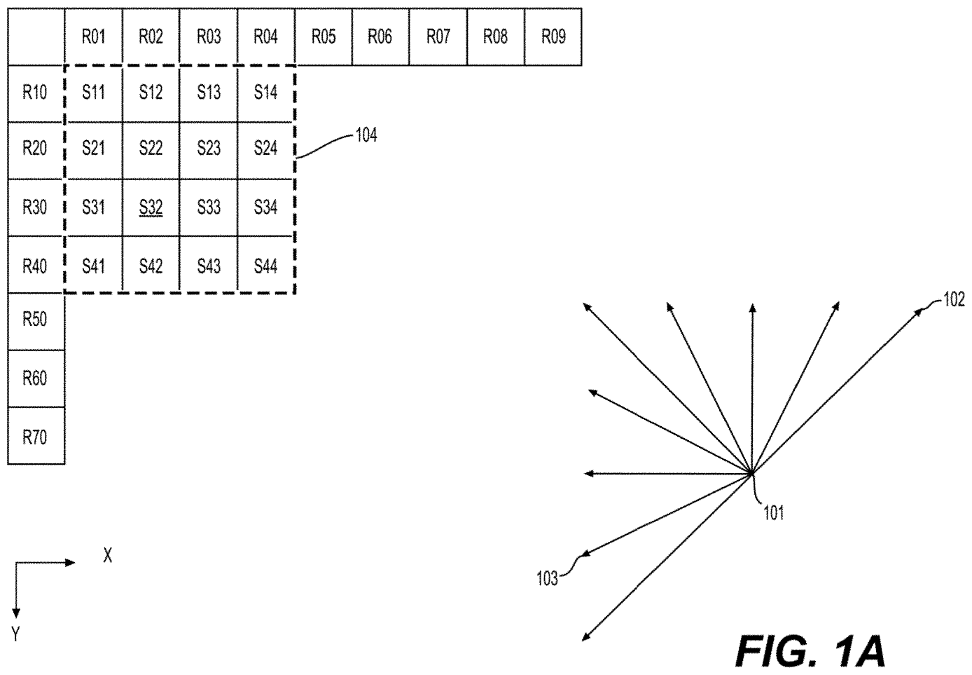

FIG. 1B is an illustration of exemplary intra prediction directions.

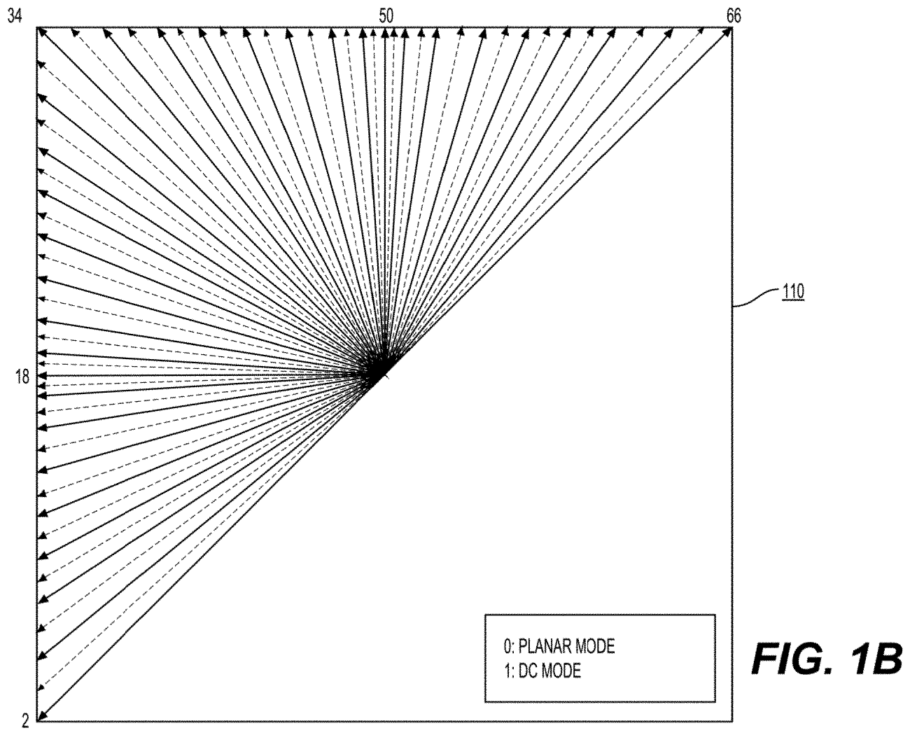

FIG. 2 shows a current block (201) and surrounding samples in accordance with an embodiment.

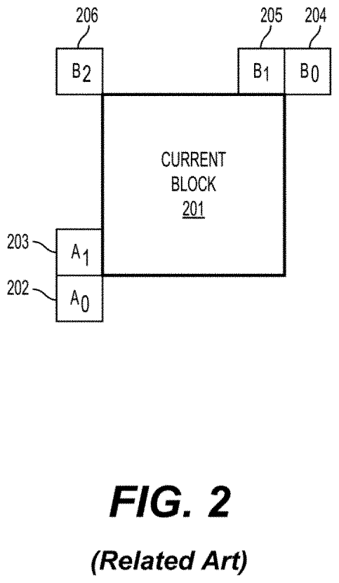

FIG. 3 is a schematic illustration of a simplified block diagram of a communication system (300) in accordance with an embodiment.

FIG. 4 is a schematic illustration of a simplified block diagram of a communication system (400) in accordance with an embodiment.

FIG. 5 is a schematic illustration of a simplified block diagram of a decoder in accordance with an embodiment.

FIG. 6 is a schematic illustration of a simplified block diagram of an encoder in accordance with an embodiment.

FIG. 7 shows a block diagram of an encoder in accordance with another embodiment.

FIG. 8 shows a block diagram of a decoder in accordance with another embodiment.

FIG. 9 shows an example of a slice header including a reference to a picture parameter set (PPS), a sequence parameter set (SPS), and a video parameter set (VPS) according to an embodiment of the disclosure.

FIG. 10 shows an exemplary image including multiple picture-in-pictures according to an embodiment of the disclosure.

FIG. 11 shows an example of an enhanced display of a local region according to an embodiment of the disclosure.

FIG. 12 shows an exemplary systematic design with subpictures and multi-layers according to an embodiment of the disclosure.

FIG. 13 shows an example of a reference subpicture scaling window in a reference picture and a subpicture scaling window in a subpicture according to an embodiment of the disclosure.

FIG. 14A shows an exemplary subpicture layout update process within a coded video sequence (CVS) according to an embodiment of the disclosure.

FIG. 14B shows an exemplary subpicture layout update process within a CVS according to an embodiment of the disclosure.

FIG. 15 shows exemplary subpicture layouts in different layers in a CVS according to an embodiment of the disclosure.

FIG. 16 shows a flow chart outlining an encoding process according to an embodiment of the disclosure.

FIG. 17 shows a flow chart outlining a decoding process according to an embodiment of the disclosure.

FIG. 18 is a schematic illustration of a computer system in accordance with an embodiment.

### DETAILED DESCRIPTION OF EMBODIMENTS

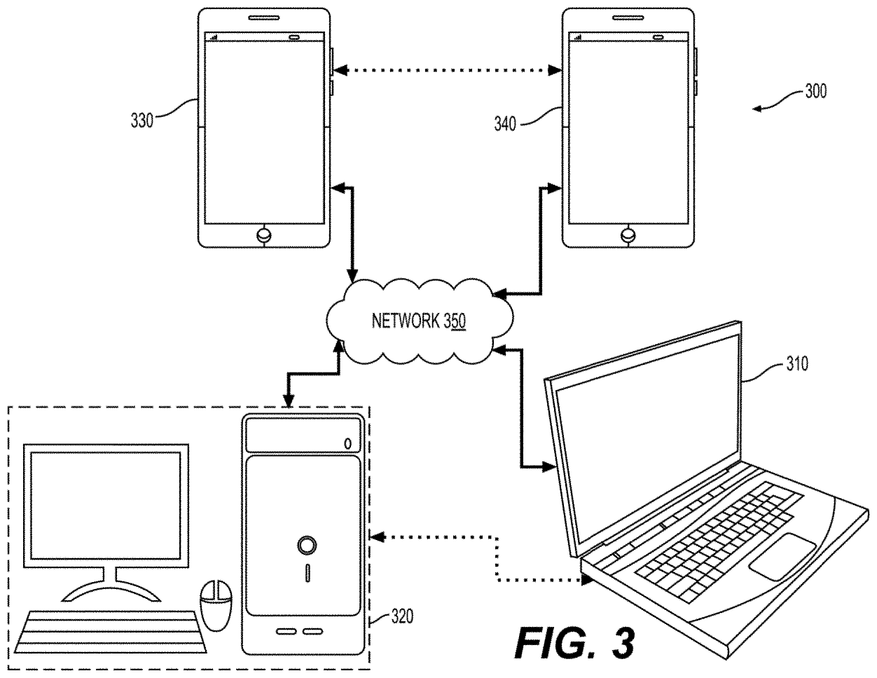

FIG. 3 illustrates a simplified block diagram of a communication system (300) according to an embodiment of the present disclosure. The communication system (300) includes a plurality of terminal devices that can communicate with each other, via, for example, a network (350). For example, the communication system (300) includes a first pair of terminal devices (310) and (320) interconnected via the network (350). In the FIG. 3 example, the first pair of terminal devices (310) and (320) performs unidirectional transmission of data. For example, the terminal device (310) may code video data (e.g., a stream of video pictures that are captured by the terminal device (310)) for transmission to the other terminal device (320) via the network (350). The encoded video data can be transmitted in the form of one or more coded video bitstreams. The terminal device (320) may receive the coded video data from the network (350), decode the coded video data to recover the video pictures and display video pictures according to the recovered video data. Unidirectional data transmission may be common in media serving applications and the like.

In another example, the communication system (300) includes a second pair of terminal devices (330) and (340) that performs bidirectional transmission of coded video data that may occur, for example, during videoconferencing. For bidirectional transmission of data, in an example, each terminal device of the terminal devices (330) and (340) may code video data (e.g., a stream of video pictures that are captured by the terminal device) for transmission to the other terminal device of the terminal devices (330) and (340) via the network (350). Each terminal device of the terminal devices (330) and (340) also may receive the coded video data transmitted by the other terminal device of the terminal devices (330) and (340), and may decode the coded video data to recover the video pictures and may display video pictures at an accessible display device according to the recovered video data.

In the FIG. 3 example, the terminal devices (310), (320), (330) and (340) may be illustrated as servers, personal computers and smart phones but the principles of the present disclosure may be not so limited. Embodiments of the present disclosure find application with laptop computers, tablet computers, media players and/or dedicated video conferencing equipment. The network (350) represents any number of networks that convey coded video data among the terminal devices (310), (320), (330) and (340), including for example wireline (wired) and/or wireless communication networks. The communication network (350) may exchange data in circuit-switched and/or packet-switched channels. Representative networks include telecommunications networks, local area networks, wide area networks and/or the Internet. For the purposes of the present discussion, the architecture and topology of the network (350) may be immaterial to the operation of the present disclosure unless explained herein below.

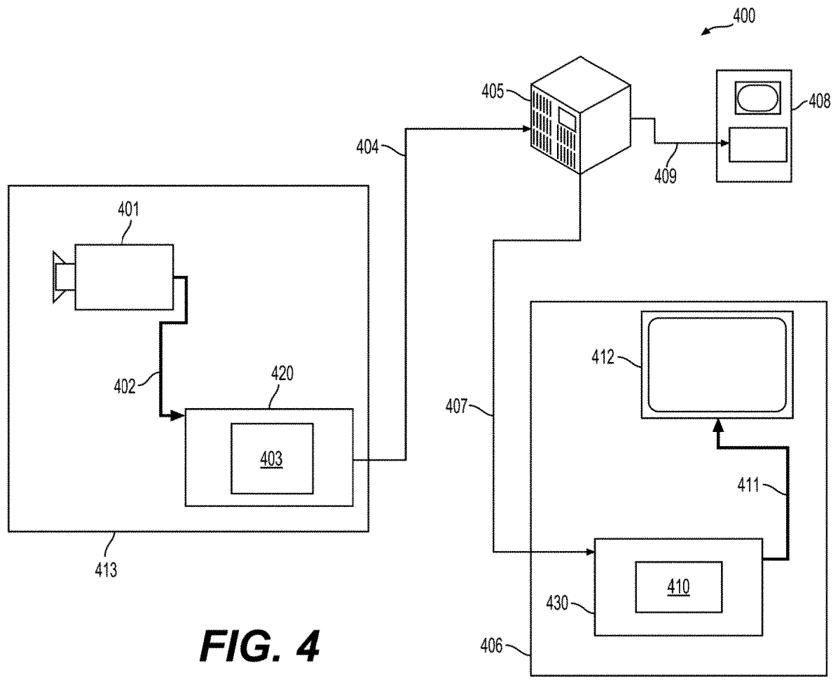

FIG. 4 illustrates, as an example for an application for the disclosed subject matter, the placement of a video encoder and a video decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem (413), that can include a video source (401), for example a digital camera, creating for example a stream of video pictures (402) that are uncompressed. In an example, the stream of video pictures (402) includes samples that are taken by the digital camera. The stream of video pictures (402), depicted as a bold line to emphasize a high data volume when compared to encoded video data (404) (or coded video bitstreams), can be processed by an electronic device (420) that includes a video encoder (403) coupled to the video source (401). The video encoder (403) can include hardware, software, or a combination thereof to enable or implement aspects of the disclosed subject matter as described in more detail below. The encoded video data (404) (or encoded video bitstream), depicted as a thin line to emphasize the lower data volume when compared to the stream of video pictures (402), can be stored on a streaming server (405) for future use. One or more streaming client subsystems, such as client subsystems (406) and (408) in FIG. 4 can access the streaming server (405) to retrieve copies (407) and (409) of the encoded video data (404). A client subsystem (406) can include a video decoder (410), for example, in an electronic device (430). The video decoder (410) decodes the incoming copy (407) of the encoded video data and creates an outgoing stream of video pictures (411) that can be rendered on a display (412) (e.g., display screen) or other rendering device (not depicted). In some streaming systems, the encoded video data (404), (407), and (409) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (420) and (430) can include other components (not shown). For example, the electronic device (420) can include a video decoder (not shown) and the electronic device (430) can include a video encoder (not shown) as well.

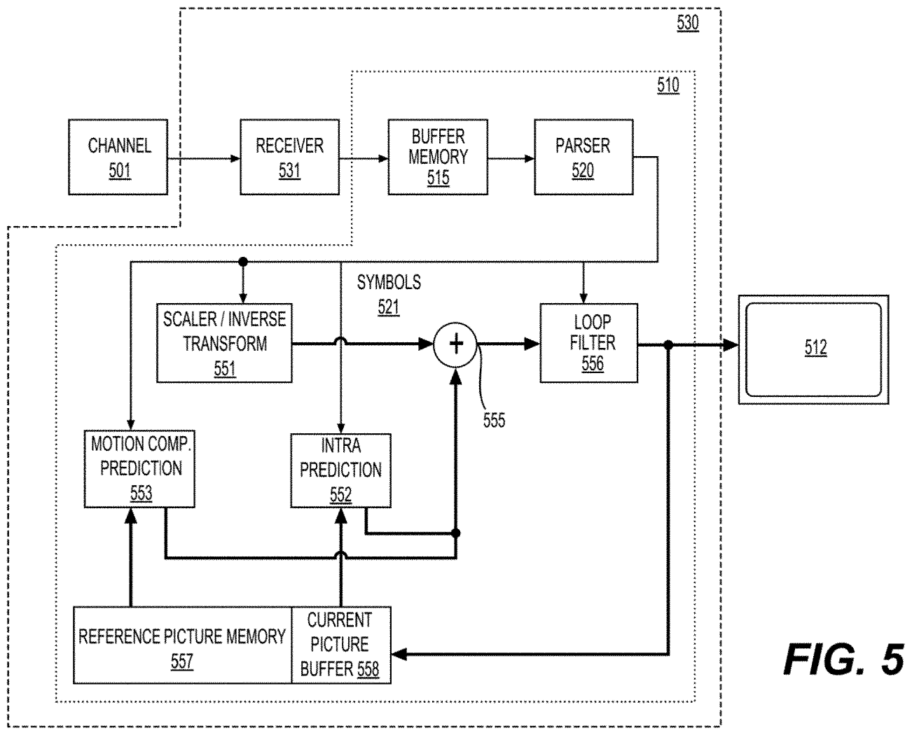

FIG. 5 shows a block diagram of a video decoder (510) according to an embodiment of the present disclosure. The video decoder (510) can be included in an electronic device (530). The electronic device (530) can include a receiver (531) (e.g., receiving circuitry). The video decoder (510) can be used in the place of the video decoder (410) in the FIG. 4 example.

The receiver (531) may receive one or more coded video sequences to be decoded by the video decoder (510); in the same or another embodiment, one coded video sequence at a time, where the decoding of each coded video sequence is independent from other coded video sequences. The coded video sequence may be received from a channel (501), which may be a hardware/software link to a storage device which stores the encoded video data. The receiver (531) may receive the encoded video data with other data, for example, coded audio data and/or ancillary data streams, that may be forwarded to their respective using entities (not depicted). The receiver (531) may separate the coded video sequence from the other data. To combat network jitter, a buffer memory (515) may be coupled in between the receiver (531) and an entropy decoder/parser (520) (“parser (520)” henceforth). In certain applications, the buffer memory (515) is part of the video decoder (510). In others, it can be outside of the video decoder (510) (not depicted). In still others, there can be a buffer memory (not depicted) outside of the video decoder (510), for example to combat network jitter, and in addition another buffer memory (515) inside the video decoder (510), for example to handle playout timing. When the receiver (531) is receiving data from a store/forward device of sufficient bandwidth and controllability, or from an isosynchronous network, the buffer memory (515) may not be needed, or can be small. For use on best effort packet networks such as the Internet, the buffer memory (515) may be required, can be comparatively large and can be advantageously of adaptive size, and may at least partially be implemented in an operating system or similar elements (not depicted) outside of the video decoder (510).

The video decoder (510) may include the parser (520) to reconstruct symbols (521) from the coded video sequence. Categories of those symbols include information used to manage operation of the video decoder (510), and potentially information to control a rendering device such as a render device (512) (e.g., a display screen) that is not an integral part of the electronic device (530) but can be coupled to the electronic device (530), as was shown in FIG. 5. The control information for the rendering device(s) may be in the form of Supplemental Enhancement Information (SEI messages) or Video Usability Information (VUI) parameter set fragments (not depicted). The parser (520) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (520) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (520) may also extract from the coded video sequence information such as transform coefficients, quantizer parameter values, motion vectors, and so forth.

The parser (520) may perform an entropy decoding/parsing operation on the video sequence received from the buffer memory (515), so as to create symbols (521).

Reconstruction of the symbols (521) can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser (520). The flow of such subgroup control information between the parser (520) and the multiple units below is not depicted for clarity.

Beyond the functional blocks already mentioned, the video decoder (510) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (551). The scaler/inverse transform unit (551) receives a quantized transform coefficient as well as control information, including which transform to use, block size, quantization factor, quantization scaling matrices, etc. as symbol(s) (521) from the parser (520). The scaler/inverse transform unit (551) can output blocks comprising sample values, that can be input into aggregator (555).

In some cases, the output samples of the scaler/inverse transform unit (551) can pertain to an intra coded block; that is: a block that is not using predictive information from previously reconstructed pictures, but can use predictive information from previously reconstructed parts of the current picture. Such predictive information can be provided by an intra picture prediction unit (552). In some cases, the intra picture prediction unit (552) generates a block of the same size and shape of the block under reconstruction, using surrounding already reconstructed information fetched from the current picture buffer (558). The current picture buffer (558) buffers, for example, partly reconstructed current picture and/or fully reconstructed current picture. The aggregator (555), in some cases, adds, on a per sample basis, the prediction information the intra prediction unit (552) has generated to the output sample information as provided by the scaler/inverse transform unit (551).

In other cases, the output samples of the scaler/inverse transform unit (551) can pertain to an inter coded, and potentially motion compensated block. In such a case, a motion compensation prediction unit (553) can access reference picture memory (557) to fetch samples used for prediction. After motion compensating the fetched samples in accordance with the symbols (521) pertaining to the block, these samples can be added by the aggregator (555) to the output of the scaler/inverse transform unit (551) (in this case called the residual samples or residual signal) so as to generate output sample information. The addresses within the reference picture memory (557) from where the motion compensation prediction unit (553) fetches prediction samples can be controlled by motion vectors, available to the motion compensation prediction unit (553) in the form of symbols (521) that can have, for example X, Y, and reference picture components. Motion compensation also can include interpolation of sample values as fetched from the reference picture memory (557) when sub-sample exact motion vectors are in use, motion vector prediction mechanisms, and so forth.

The output samples of the aggregator (555) can be subject to various loop filtering techniques in the loop filter unit (556). Video compression technologies can include in-loop filter technologies that are controlled by parameters included in the coded video sequence (also referred to as coded video bitstream) and made available to the loop filter unit (556) as symbols (521) from the parser (520), but can also be responsive to meta-information obtained during the decoding of previous (in decoding order) parts of the coded picture or coded video sequence, as well as responsive to previously reconstructed and loop-filtered sample values.

The output of the loop filter unit (556) can be a sample stream that can be output to the render device (512) as well as stored in the reference picture memory (557) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (520)), the current picture buffer (558) can become a part of the reference picture memory (557), and a fresh current picture buffer can be reallocated before commencing the reconstruction of the following coded picture.

The video decoder (510) may perform decoding operations according to a predetermined video compression technology in a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (531) may receive additional (redundant) data with the encoded video. The additional data may be included as part of the coded video sequence(s). The additional data may be used by the video decoder (510) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

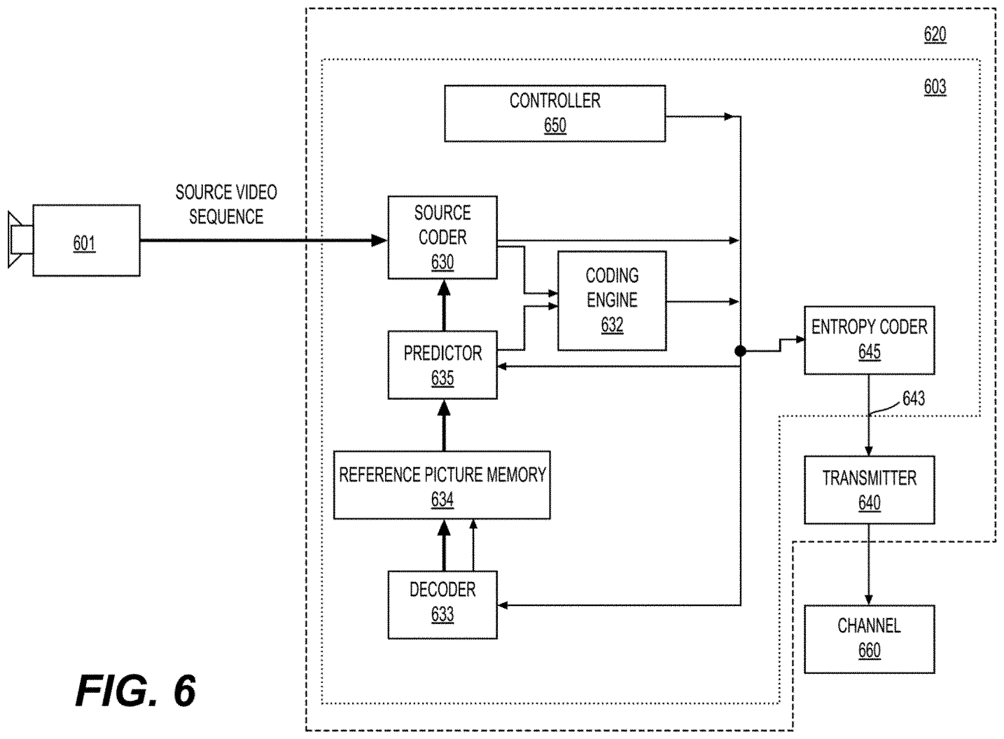

FIG. 6 shows a block diagram of a video encoder (603) according to an embodiment of the present disclosure. The video encoder (603) is included in an electronic device (620). The electronic device (620) includes a transmitter (640) (e.g., transmitting circuitry). The video encoder (603) can be used in the place of the video encoder (403) in the FIG. 4 example.

The video encoder (603) may receive video samples from a video source (601) (that is not part of the electronic device (620) in the FIG. 6 example) that may capture video image(s) to be coded by the video encoder (603). In another example, the video source (601) is a part of the electronic device (620).

The video source (601) may provide the source video sequence to be coded by the video encoder (603) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (601) may be a storage device storing previously prepared video. In a videoconferencing system, the video source (601) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the video encoder (603) may code and compress the pictures of the source video sequence into a coded video sequence (643) in real time or under any other time constraints as required by the application. Enforcing appropriate coding speed is one function of a controller (650). In some embodiments, the controller (650) controls other functional units as described below and is functionally coupled to the other functional units. The coupling is not depicted for clarity. Parameters set by the controller (650) can include rate control related parameters (picture skip, quantizer, lambda value of rate-distortion optimization techniques, . . . ), picture size, group of pictures (GOP) layout, maximum motion vector search range, and so forth. The controller (650) can be configured to have other suitable functions that pertain to the video encoder (603) optimized for a certain system design.

In some embodiments, the video encoder (603) is configured to operate in a coding loop. As an oversimplified description, in an example, the coding loop can include a source coder (630) (e.g., responsible for creating symbols, such as a symbol stream, based on an input picture to be coded, and a reference picture(s)), and a (local) decoder (633) embedded in the video encoder (603). The decoder (633) reconstructs the symbols to create the sample data in a similar manner as a (remote) decoder also would create (as any compression between symbols and coded video bitstream is lossless in the video compression technologies considered in the disclosed subject matter). The reconstructed sample stream (sample data) is input to the reference picture memory (634). As the decoding of a symbol stream leads to bit-exact results independent of decoder location (local or remote), the content in the reference picture memory (634) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (633) can be the same as of a “remote” decoder, such as the video decoder (510), which has already been described in detail above in conjunction with FIG. 5. Briefly referring also to FIG. 5, however, as symbols are available and encoding/decoding of symbols to a coded video sequence by an entropy coder (645) and the parser (520) can be lossless, the entropy decoding parts of the video decoder (510), including the buffer memory (515), and parser (520) may not be fully implemented in the local decoder (633).

In an embodiment, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (630) may perform motion compensated predictive coding, which codes an input picture predictively with reference to one or more previously coded picture from the video sequence that were designated as “reference pictures.” In this manner, the coding engine (632) codes differences between pixel blocks of an input picture and pixel blocks of reference picture(s) that may be selected as prediction reference(s) to the input picture.

The local video decoder (633) may decode coded video data of pictures that may be designated as reference pictures, based on symbols created by the source coder (630). Operations of the coding engine (632) may advantageously be lossy processes. When the coded video data may be decoded at a video decoder (not shown in FIG. 6), the reconstructed video sequence typically may be a replica of the source video sequence with some errors. The local video decoder (633) replicates decoding processes that may be performed by the video decoder on reference pictures and may cause reconstructed reference pictures to be stored in the reference picture memory (634). In this manner, the video encoder (603) may store copies of reconstructed reference pictures locally that have common content as the reconstructed reference pictures that will be obtained by a far-end video decoder (absent transmission errors).

The predictor (635) may perform prediction searches for the coding engine (632). That is, for a new picture to be coded, the predictor (635) may search the reference picture memory (634) for sample data (as candidate reference pixel blocks) or certain metadata such as reference picture motion vectors, block shapes, and so on, that may serve as an appropriate prediction reference for the new pictures. The predictor (635) may operate on a sample block-by-pixel block basis to find appropriate prediction references. In some cases, as determined by search results obtained by the predictor (635), an input picture may have prediction references drawn from multiple reference pictures stored in the reference picture memory (634).

The controller (650) may manage coding operations of the source coder (630), including, for example, setting of parameters and subgroup parameters used for encoding the video data.

Output of all aforementioned functional units may be subjected to entropy coding in the entropy coder (645). The entropy coder (645) translates the symbols as generated by the various functional units into a coded video sequence, by lossless compressing the symbols according to technologies such as Huffman coding, variable length coding, arithmetic coding, and so forth.

The transmitter (640) may buffer the coded video sequence(s) as created by the entropy coder (645) to prepare for transmission via a communication channel (660), which may be a hardware/software link to a storage device which would store the encoded video data. The transmitter (640) may merge coded video data from the video encoder (603) with other data to be transmitted, for example, coded audio data and/or ancillary data streams (sources not shown).

The controller (650) may manage operation of the video encoder (603). During coding, the controller (650) may assign to each coded picture a certain coded picture type, which may affect the coding techniques that may be applied to the respective picture. For example, pictures often may be assigned as one of the following picture types:

An Intra Picture (I picture) may be one that may be coded and decoded without using any other picture in the sequence as a source of prediction. Some video codecs allow for different types of intra pictures, including, for example Independent Decoder Refresh (“IDR”) Pictures. A person skilled in the art is aware of those variants of I pictures and their respective applications and features.

A predictive picture (P picture) may be one that may be coded and decoded using intra prediction or inter prediction using at most one motion vector and reference index to predict the sample values of each block.

A bi-directionally predictive picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (603) may perform coding operations according to a predetermined video coding technology or standard, such as ITU-T Rec. H.265. In its operation, the video encoder (603) may perform various compression operations, including predictive coding operations that exploit temporal and spatial redundancies in the input video sequence. The coded video data, therefore, may conform to a syntax specified by the video coding technology or standard being used.

In an embodiment, the transmitter (640) may transmit additional data with the encoded video. The source coder (630) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

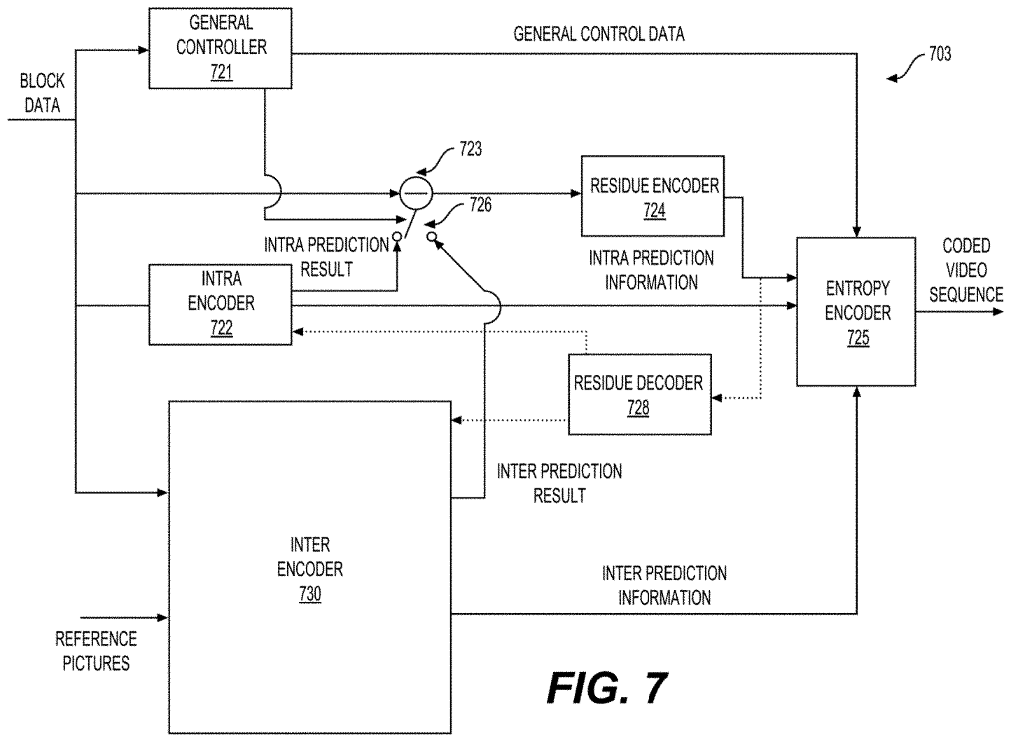

FIG. 7 shows a diagram of a video encoder (703) according to another embodiment of the disclosure. The video encoder (703) is configured to receive a processing block (e.g., a prediction block) of sample values within a current video picture in a sequence of video pictures, and encode the processing block into a coded picture that is part of a coded video sequence. In an example, the video encoder (703) is used in the place of the video encoder (403) in the FIG. 4 example.

In an HEVC example, the video encoder (703) receives a matrix of sample values for a processing block, such as a prediction block of 8×8 samples, and the like. The video encoder (703) determines whether the processing block is best coded using intra mode, inter mode, or bi-prediction mode using, for example, rate-distortion optimization. When the processing block is to be coded in intra mode, the video encoder (703) may use an intra prediction technique to encode the processing block into the coded picture; and when the processing block is to be coded in inter mode or bi-prediction mode, the video encoder (703) may use an inter prediction or bi-prediction technique, respectively, to encode the processing block into the coded picture. In certain video coding technologies, merge mode can be an inter picture prediction submode where the motion vector is derived from one or more motion vector predictors without the benefit of a coded motion vector component outside the predictors. In certain other video coding technologies, a motion vector component applicable to the subject block may be present. In an example, the video encoder (703) includes other components, such as a mode decision module (not shown) to determine the mode of the processing blocks.

In the FIG. 7 example, the video encoder (703) includes the inter encoder (730), an intra encoder (722), a residue calculator (723), a switch (726), a residue encoder (724), a general controller (721), and an entropy encoder (725) coupled together as shown in FIG. 7.

The inter encoder (730) is configured to receive the samples of the current block (e.g., a processing block), compare the block to one or more reference blocks in reference pictures (e.g., blocks in previous pictures and later pictures), generate inter prediction information (e.g., description of redundant information according to inter encoding technique, motion vectors, merge mode information), and calculate inter prediction results (e.g., predicted block) based on the inter prediction information using any suitable technique. In some examples, the reference pictures are decoded reference pictures that are decoded based on the encoded video information.

The intra encoder (722) is configured to receive the samples of the current block (e.g., a processing block), in some cases compare the block to blocks already coded in the same picture, generate quantized coefficients after transform, and in some cases also intra prediction information (e.g., an intra prediction direction information according to one or more intra encoding techniques). In an example, the intra encoder (722) also calculates intra prediction results (e.g., predicted block) based on the intra prediction information and reference blocks in the same picture.

The general controller (721) is configured to determine general control data and control other components of the video encoder (703) based on the general control data. In an example, the general controller (721) determines the mode of the block, and provides a control signal to the switch (726) based on the mode. For example, when the mode is the intra mode, the general controller (721) controls the switch (726) to select the intra mode result for use by the residue calculator (723), and controls the entropy encoder (725) to select the intra prediction information and include the intra prediction information in the bitstream; and when the mode is the inter mode, the general controller (721) controls the switch (726) to select the inter prediction result for use by the residue calculator (723), and controls the entropy encoder (725) to select the inter prediction information and include the inter prediction information in the bitstream.

The residue calculator (723) is configured to calculate a difference (residue data) between the received block and prediction results selected from the intra encoder (722) or the inter encoder (730). The residue encoder (724) is configured to operate based on the residue data to encode the residue data to generate the transform coefficients. In an example, the residue encoder (724) is configured to convert the residue data from a spatial domain to a frequency domain, and generate the transform coefficients. The transform coefficients are then subject to quantization processing to obtain quantized transform coefficients. In various embodiments, the video encoder (703) also includes a residue decoder (728). The residue decoder (728) is configured to perform inverse-transform, and generate the decoded residue data. The decoded residue data can be suitably used by the intra encoder (722) and the inter encoder (730). For example, the inter encoder (730) can generate decoded blocks based on the decoded residue data and inter prediction information, and the intra encoder (722) can generate decoded blocks based on the decoded residue data and the intra prediction information. The decoded blocks are suitably processed to generate decoded pictures and the decoded pictures can be buffered in a memory circuit (not shown) and used as reference pictures in some examples.

The entropy encoder (725) is configured to format the bitstream to include the encoded block. The entropy encoder (725) is configured to include various information according to a suitable standard, such as the HEVC standard. In an example, the entropy encoder (725) is configured to include the general control data, the selected prediction information (e.g., intra prediction information or inter prediction information), the residue information, and other suitable information in the bitstream. Note that, according to the disclosed subject matter, when coding a block in the merge submode of either inter mode or bi-prediction mode, there is no residue information.

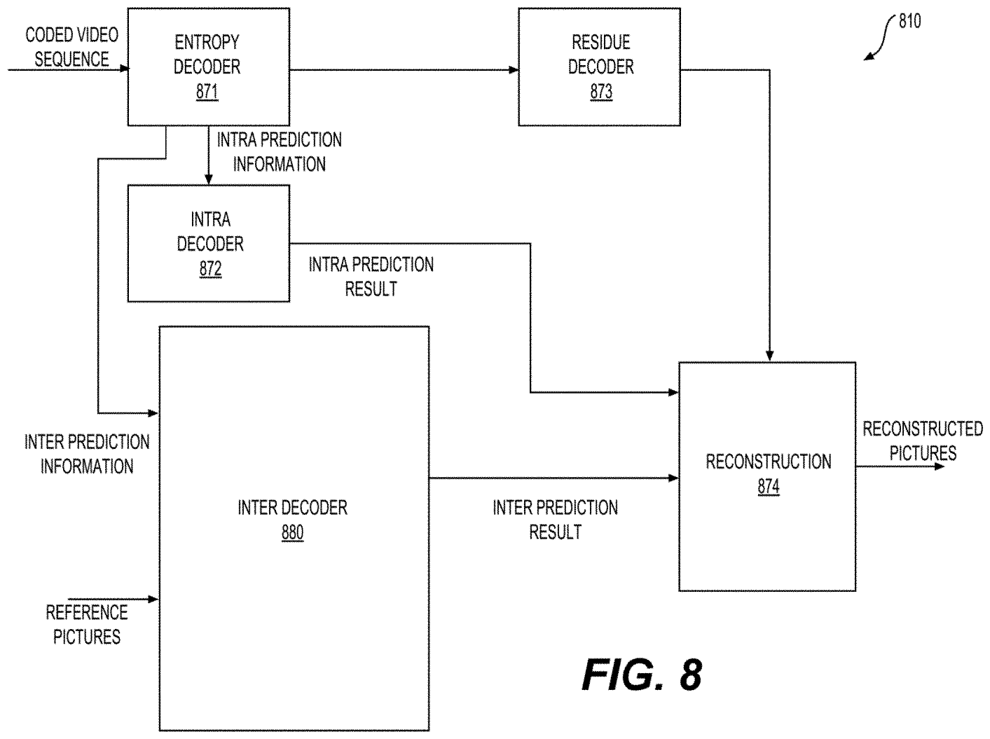

FIG. 8 shows a diagram of a video decoder (810) according to another embodiment of the disclosure. The video decoder (810) is configured to receive coded pictures that are part of a coded video sequence, and decode the coded pictures to generate reconstructed pictures. In an example, the video decoder (810) is used in the place of the video decoder (410) in the FIG. 4 example.

In the FIG. 8 example, the video decoder (810) includes an entropy decoder (871), an inter decoder (880), a residue decoder (873), a reconstruction module (874), and an intra decoder (872) coupled together as shown in FIG. 8.

The entropy decoder (871) can be configured to reconstruct, from the coded picture, certain symbols that represent the syntax elements of which the coded picture is made up. Such symbols can include, for example, the mode in which a block is coded (such as, for example, intra mode, inter mode, bi-predicted mode, the latter two in merge submode or another submode), prediction information (such as, for example, intra prediction information or inter prediction information) that can identify certain sample or metadata that is used for prediction by the intra decoder (872) or the inter decoder (880), respectively, residual information in the form of, for example, quantized transform coefficients, and the like. In an example, when the prediction mode is inter or bi-predicted mode, the inter prediction information is provided to the inter decoder (880); and when the prediction type is the intra prediction type, the intra prediction information is provided to the intra decoder (872). The residual information can be subject to inverse quantization and is provided to the residue decoder (873).

The inter decoder (880) is configured to receive the inter prediction information, and generate inter prediction results based on the inter prediction information.

The intra decoder (872) is configured to receive the intra prediction information, and generate prediction results based on the intra prediction information.

The residue decoder (873) is configured to perform inverse quantization to extract de-quantized transform coefficients, and process the de-quantized transform coefficients to convert the residual from the frequency domain to the spatial domain. The residue decoder (873) may also require certain control information (to include the Quantizer Parameter (QP)), and that information may be provided by the entropy decoder (871) (data path not depicted as this may be low volume control information only).

The reconstruction module (874) is configured to combine, in the spatial domain, the residual as output by the residue decoder (873) and the prediction results (as output by the inter or intra prediction modules as the case may be) to form a reconstructed block, that may be part of the reconstructed picture, which in turn may be part of the reconstructed video. It is noted that other suitable operations, such as a deblocking operation and the like, can be performed to improve the visual quality.

It is noted that the video encoders (403), (603), and (703), and the video decoders (410), (510), and (810) can be implemented using any suitable technique. In an embodiment, the video encoders (403), (603), and (703), and the video decoders (410), (510), and (810) can be implemented using one or more integrated circuits. In another embodiment, the video encoders (403), (603), and (603), and the video decoders (410), (510), and (810) can be implemented using one or more processors that execute software instructions.

According to an embodiment of the disclosure, a bitstream can include one or more coded video sequences (CVSs). A CVS can be independently coded from other CVSs. Each CVS can include one or more layers, and each layer can be a representation of a video with a specific quality (e.g., a spatial resolution), or a representation of a certain component interpretation property, e.g., as a depth map, a transparency map, or a perspective view. In a temporal dimension, each CVS can include one or more access units (AUs). Each AU can include one or more pictures of different layers that correspond to a same time instance. A coded layer video sequence (CLVS) is a layer-wise CVS that can include a sequence of picture units in the same layer. If a bitstream has multiple layers, a CVS in the bitstream can have one or more CLVSs for each layer.

In an embodiment, a CVS includes a sequence of AUs where the sequence of AUs includes, in a decoding order, an intra random access point (IRAP) AU, followed by zero or more AUs that are not IRAP AUs. In an example, the zero or more AUs includes all subsequent AUs up to but not including any subsequent AU that is an IRAP AU. In an example, a CLVS includes a sequence of pictures and the associated non-video coding layer (VCL) network abstraction layer (NAL) units of a base layer of a CVS.

Parameter sets can be part of a video bitstream or can be received by a decoder through other means (including out-of-band transmission using a reliable channel, hard coding in encoder and decoder, and the like). Parameter sets can include but are not limited to a video parameter set (VPS), a sequence parameter set (SPS), a picture parameter set (PPS), and the like.

A high-level syntax structure can include a VPS, a SPS, a PPS, a supplemental enhancement information (SEI) message, a slice header, a picture header, a tile group header, and the like.

A VPS can include information that is applicable to multiple layers as well as sub-layers. In an example, each layer of a video sequence refers to a same VPS.

A SPS can include information that applies to slices of a coded video sequence. A SPS can include one or more of: 1) a self-reference or an identifier (ID); 2) decoder operation point related information (e.g., profile, level, a picture size, number of sub-layers); 3) enabling flags for certain tools within a profile, and associated coding tool parameters if the tool is enabled; 4) information restricting the flexibility of structures and transform coefficient coding; 5) temporal scalability control; and 6) visual usability information (VUI).

A PPS can include syntax elements that apply to zero or more entire coded pictures, for example, as determined by a syntax element found in a slice header. A PPS can include information that may change from picture to picture. A PPS can include one or more of: 1) a self-reference or ID; 2) initial picture control information such as initial quantization parameter (QP), a number of flags indicating the use of, or presence of, certain tools or control information in a slice header; and 3) tiling information.

A slice header can include information that can change from slice to slice, as well as such picture related information that is relatively small or relevant only for certain slices or picture types.

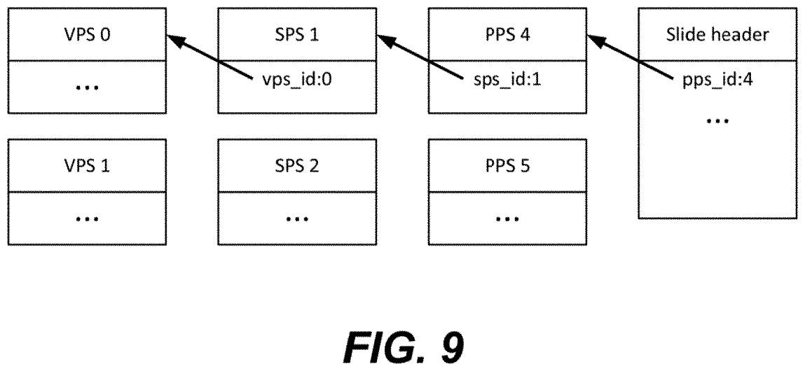

FIG. 9 shows an example of a slice header including a reference to a PPS, an SPS, and a VPS according to an embodiment of the disclosure. The slice header refers to the PPS (e.g., pps_id:4). The PPS (e.g., pps_id:4) can include a reference to the SPS (e.g., sps_id:1). The SPS (e.g., sps_id:1) can include a reference to the VPS (e.g., vps_id:0).

Each type of parameter set can include an extension mechanism, which allows extending the parameter set in future versions of video coding technologies or standards.

A subpicture in a picture may refer to a rectangular arrangement of samples, blocks, macroblocks, CUs, or similar entities that are semantically grouped, and that may be independently coded in changed resolution. One or more subpictures may form a picture. One or more coded subpictures may form a coded picture. One or more subpictures may be assembled into a picture, and one or more subpictures may be extracted from a picture. In certain environments, one or more coded subpictures may be assembled in the compressed domain without transcoding to the sample level into a coded picture. In an embodiment, one or more coded subpictures may be extracted from a coded picture in the compressed domain.

In an embodiment, a picture includes one or more subpictures. Each subpicture may cover a local region or the entire region of the picture. A region supported by a subpicture may or may not overlap with another region supported by another subpicture. A region covered by one or more subpictures may or may not cover the entire region of a picture. If a picture includes a subpicture, the region supported by the subpicture may be identical to the region supported by the picture.

A subpicture may be coded by a coding method similar to a coding method used for the coded picture, such as described in the disclosure. A subpicture may be independently coded or may be coded dependent on another subpicture or a coded picture. A subpicture may or may not have any parsing dependency from another subpicture or a coded picture.

A coded subpicture may be contained in one or more layers. A coded subpicture in a layer may have a different spatial resolution. The original subpicture may be spatially resampled (e.g., up-sampled or down-sampled), coded with different spatial resolution parameters, and contained in a bitstream corresponding to a layer.

A subpicture with (W, H), where W indicates the width of the subpicture and H indicates the height of the subpicture, respectively, may be coded and contained in the coded bitstream corresponding to layer 0. The up-sampled (or down-sampled) subpicture from the subpicture with the original spatial resolution may be coded and contained in the coded bitstream corresponding to layer k. The up-sampled (or down-sampled) subpicture has a width of W× S_{w,k} and a height of H× S_{h,k}. Parameters S_{w,k} and S_{h,k} indicate a horizontal resampling ratio and a vertical resampling ratio, respectively.

A coded subpicture in a layer may have a different visual quality from that of the coded subpicture in another layer in the same subpicture or a different subpicture.

A coded subpicture in a layer may be independently decodable, without any parsing or decoding dependency from a coded subpicture in another layer of the same local region. The subpicture layer, which can be independently decodable without referencing another subpicture layer of the same local region, may be the independent subpicture layer. A coded subpicture in the independent subpicture layer may or may not have a decoding or parsing dependency from a previously coded subpicture in the same subpicture layer, but the coded subpicture may not have any dependency from a coded picture in another subpicture layer.

A coded subpicture in a layer may be dependently decodable, with parsing or decoding dependency from a coded subpicture in another layer of the same local region. The subpicture layer, which can be dependently decodable with referencing another subpicture layer of the same local region, may be the dependent subpicture layer. A coded subpicture in the dependent subpicture may reference a coded subpicture in the same subpicture, a previously coded subpicture in the same subpicture layer, or both reference subpictures.

A coded subpicture may include one or more independent subpicture layers and one or more dependent subpicture layers. At least one independent subpicture layer may be present for a coded subpicture. A value of the layer identifier (e.g., layer_id), which may be present in a NAL unit header or another high-level syntax structure, of the independent subpicture layer may be equal to 0. The subpicture layer with the layer_id equal to 0 may be a base subpicture layer.

A picture may include one or more foreground subpictures and one background subpicture. The region supported by a background subpicture may be equal to the region of the picture. The region supported by a foreground subpicture may overlap with the region supported by a background subpicture. The background subpicture may be a base subpicture layer, and the foreground subpicture may be a non-base (e.g., enhancement) subpicture layer. One or more non-base subpicture layers may reference the same base layer for decoding. Each non-base subpicture layer with a first layer_id may reference a non-base subpicture layer with a second layer_id, where the first layer_id is greater than the second layer_id.

A picture may include one or more foreground subpictures with or without a background subpicture. Each subpicture may have its own base subpicture layer and one or more non-base (e.g., enhancement) layers. Each base subpicture layer may be referenced by one or more non-base subpicture layers.

Each coded subpicture in a base or non-base subpicture layer may be referenced by one or more non-base layer subpictures belonging to the same subpicture and one or more non-base layer subpictures, which are not in the same subpicture.

A CVS may include a group of coded pictures. The CVS may include one or more coded subpicture sequences (CSPS) where the CSPS may include a group of coded subpictures covering the same local region of the picture. A CSPS may have the same or a different temporal resolution than that of the CVS.

A CSPS may be coded and contained in one or more layers. A CSPS may include one or more CSPS layers. Decoding one or more CSPS layers corresponding to a CSPS may reconstruct a sequence of subpictures corresponding to the same local region.

The disclosure includes techniques for subpicture-wise reference picture resampling and scalability for video streaming.

Image/video coding technologies, such as VVC, has been developed for various applications including ultra-high definition (UHD) video streaming, immersive media solution (e.g., 360-degree video, point cloud, 6 degrees-of-freedom), game and/or e-sport. E-Sport can be used for live broadcast and/or real-time streaming events. In an example, E-Sport as an online application includes competitive video gaming with multiple players battling against each other, for example, in teams. Matches can be streamed live to fans. With a cloud-based game streaming solution (e.g. Tencent's Start), E-Sport allows professional gamers to remotely play a match simultaneously. The game play with commenter's video and audio can be broadcasted to audiences in real-time.

Computer-generated (CG) test sequences have been studied, including mobile game content, such as a multiplayer online battle arena (MOBA) game developed for mobile (e.g., Arena of Valor). CG content may have unique characteristics that are distinguished from the natural images captured by a camera. Certain coding tools (e.g. IBC), specialized for game content sequences, have been developed and adopted. Useful functionalities and system-interfaces, with designs of high-level syntax have been developed.

According to an embodiment of the disclosure, local enhancement of visual quality or resolution can be employed.

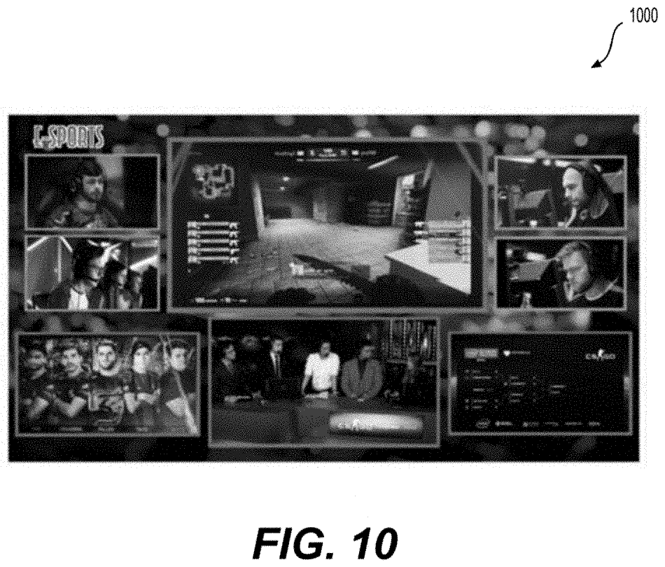

Certain live videos in E-Sport matches, such as images of commentators, players, a scoreboard, a screen of a game, can be displayed and viewed by audiences. To display multi-images on a screen of a player at a same time, multiple windows for picture-in-picture (PIP) can be advantageous for E-Sport broadcasting. FIG. 10 shows an exemplary image (or picture) (1000) including multiple PIPs in E-Sport broadcasting according to an embodiment of the disclosure.

An E-Sport broadcasting system can mix and/or switch multiple video inputs. The multiple video inputs can include video inputs associated with team-players, commentators, and a game video. A main broadcasting video (or a main video) that mixes a subset (e.g., the most interesting input videos) or an entire set of the multiple video inputs to a video sequence can be encoded as a main bitstream and can be streamed to remote audiences (e.g., all remote audiences). The main bitstream can include popular input videos. The visual quality of each input video may be relatively low depending on a respective picture resolution or a bitrate.

An individual input video can be additionally encoded with a higher quality and/or a higher resolution and optionally transmitted to audiences as a separated bitstream. An individual video can be dependently encoded by referencing the main video where the main video can include the individual video as a PIP. In an example, the individual video can be encoded as an enhancement layer of a local region of the main video (e.g., a base layer), by referencing the decoded picture(s) in the main video. In an example, the enhancement layer may be independently encoded without any decoding dependency on the main video and is transmitted as a simulcast.

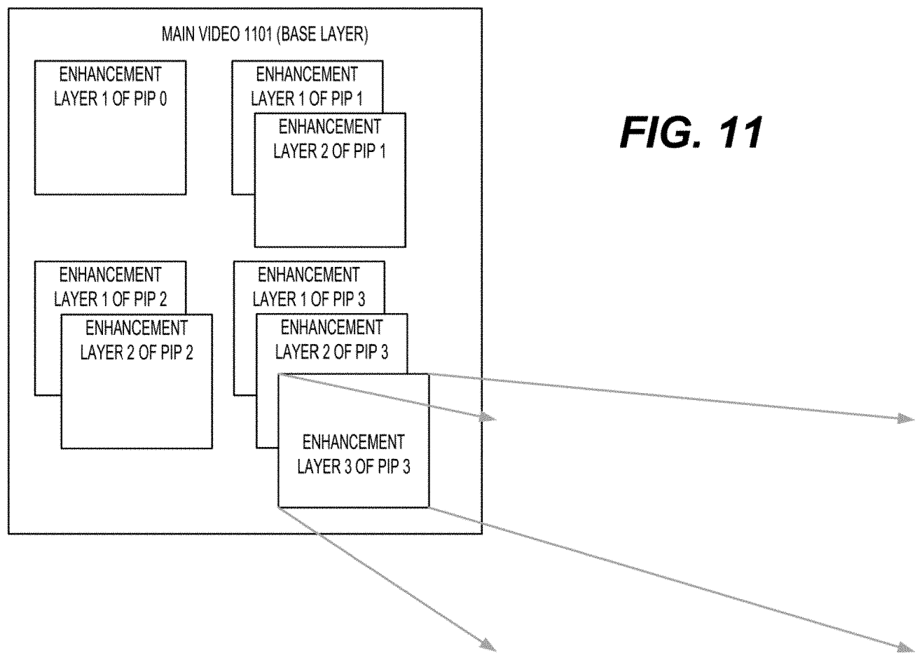

FIG. 11 shows an example of an enhanced display of a local region according to an embodiment of the disclosure. In terms of user experience, when a client or audience (user or viewer) receives a main video (1101) and one or more enhanced videos of local regions, the audience can select one of the main video and the one or more enhanced videos of the local regions. Referring to FIG. 11, the local regions can include a region 0 covered by a PIP 0, a region 1 covered by a PIP 1, a region 2 covered by a PIP 2, and a region 3 covered by a PIP 3. The one or more enhanced videos of the local regions can include an enhanced video of the PIP 0 of the region 0 in an enhancement layer 1 (or an enhancement layer 1 of PIP 0), an enhanced video of the PIP 1 of the region 1 in the enhancement layer 1 (or an enhancement layer 1 of PIP 1), an enhanced video of the PIP 1 of the region 1 in an enhancement layer 2 (or an enhancement layer 2 of PIP 1), an enhanced video of the PIP 2 of the region 2 in the enhancement layer 1 (or an enhancement layer 1 of PIP 2), an enhanced video of the PIP 2 of the region 2 in the enhancement layer 2 (or an enhancement layer 2 of PIP 2), an enhanced video of the PIP 3 of the region 3 in the enhancement layer 1 (or an enhancement layer 1 of PIP 3), an enhanced video of the PIP 3 of the region 3 in the enhancement layer 2 (or an enhancement layer 2 of PIP 3), and an enhanced video of the PIP 3 of the region 3 in the enhancement layer 3 (or an enhancement layer 3 of PIP 3).

If the audience chooses the main video (1101), the PIPs (e.g., all PIPs), such as the PIPs 0-3, within a background picture can be displayed. If the audience chooses a specific PIP (e.g., one of the one or more enhanced videos, such as the enhancement layer 3 of PIP 3), the PIP (e.g., the PIP 3) can be enlarged and displayed with an enhanced visual quality as compared to the decoded corresponding region of the main video (1101). In an example, the enhancement layer 3 of PIP 3 is selected by an audience to be displayed at a spatial resolution that is higher than a spatial resolution of the PIP 3 in the main video, a spatial resolution of the enhancement layer 1 of PIP 3, and a spatial resolution of the enhancement layer 2 of PIP 3.

The above descriptions regarding PIPs in FIG. 11 can be adapted if the PIPs in FIG. 11 are replaced by respective subpictures. For example, a local region can be covered by a respective subpicture. The main video can include subpictures in the base layer. One or more enhanced videos of local regions can be included in the bitstream. An example of an enhanced video of a local region is an enhanced video of a subpicture of the region 0 in an enhancement layer 1.

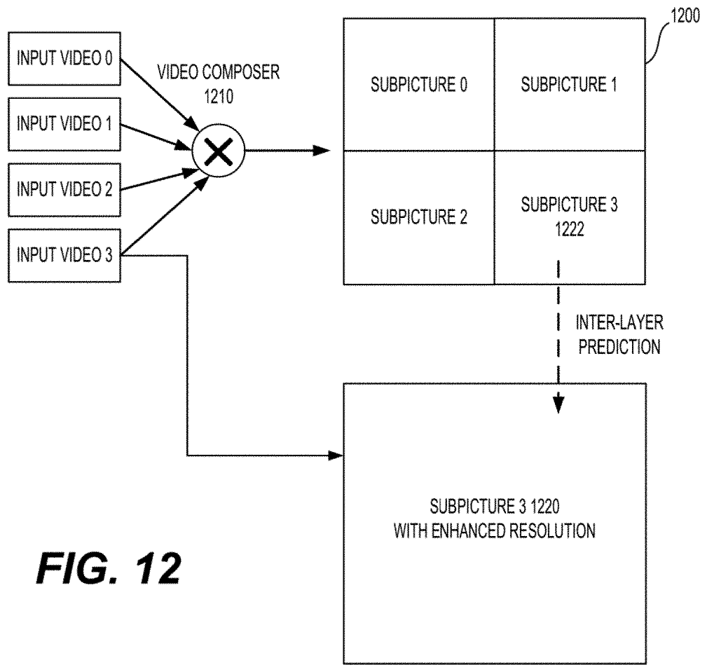

FIG. 12 shows an exemplary systematic design with subpictures and multi-layers according to an embodiment of the disclosure. Multiple input videos (e.g., input videos 0-3) can be mixed or combined by a video composer (1210) into a main video (1200). A region (e.g., a rectangular region) of the main video (1200) corresponding to an input video (e.g., the input video 0) may be encoded as a subpicture (e.g., a VVC subpicture coded based on VVC), such as a subpicture 0. Referring to FIG. 12, subpictures 0-3 correspond to the input videos 0-3, respectively.

A coded bitstream of the main video (1200) can include multiple subpictures (e.g., the subpictures 0-3). The coded bitstream of the main video (1200) can include multiple sub-bitstreams corresponding to the subpictures (e.g., the subpictures 0-3). For example, the sub-bitstreams 0-3 correspond to the subpictures 0-3, respectively. A sub-bitstream corresponding to a subpicture can be extractible from the main bitstream and can be independently decodable. Each sub-bitstream may include one or more layers with different qualities (e.g., different spatial resolutions or visual qualities). A sub-bitstream may be referenced by another sub-bitstream including a subpicture layer with a higher resolution. Referring to FIG. 12, the sub-bitstream 3 corresponding to the sub-picture 3 (1222) may be referenced by an enhanced sub-bitstream 3 corresponding to the sub-picture 3 (1220) with an enhanced resolution (e.g., higher resolution). For example, the subpicture 3 (1220) in a higher layer (e.g., layer 1) is predicted based on the subpicture 3 (1222) in a base layer using an inter-layer prediction.

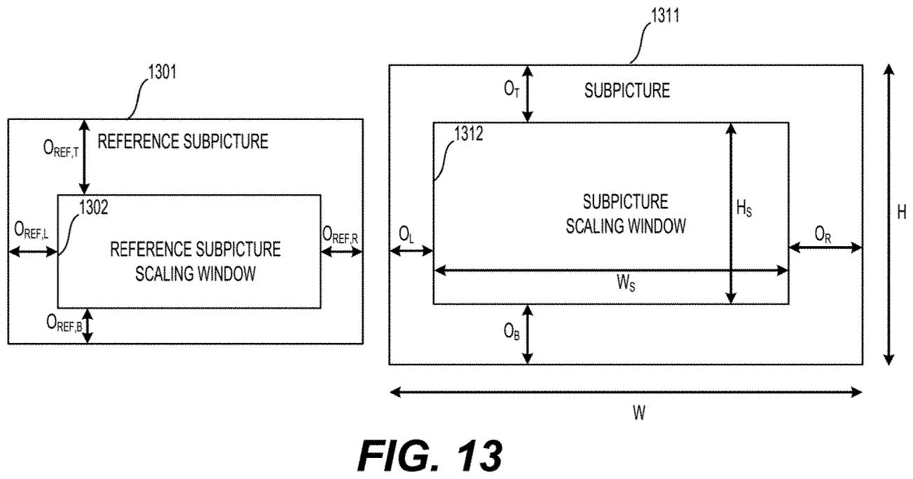

When spatial resolutions of subpictures change within a CVS, a subpicture can be decoded by performing subpicture-wise reference picture resampling. FIG. 13 shows an example of a reference subpicture scaling window (1302) in a reference subpicture (1301) and a subpicture scaling window (1312) in a subpicture (1311) according to an embodiment of the disclosure. The subpicture (1311) can be one of subpictures in a picture, such as described in FIGS. 11-12. In an example, a subpicture (e.g., the subpicture (1311)) to be decoded has a different spatial resolution or a different size from a reference subpicture (e.g., the reference subpicture (1301)). The subpicture-wise reference picture resampling can be performed to match the spatial resolutions or the sizes of the subpicture and the reference subpicture. The reference subpicture can be resampled based on the sizes of the subpicture and the reference subpicture.

In an example, the reference subpicture is resampled based on the sizes of the subpicture and the reference subpicture as well as subpicture scaling window information of the subpicture and/or reference subpicture scaling window information of the reference subpicture. Referring to FIG. 13, the subpicture scaling window information of the subpicture (1311) can indicate dimension information and/or position information of the subpicture scaling window (1312). In an example, the subpicture scaling window information of the subpicture (1311) includes first offsets including a left offset O_{L}, a right offset O_{R}, a top offset O_{T}, and a bottom offset OB of the subpicture scaling window (1312) with respect to the subpicture (1311). The dimension and the position of the subpicture scaling window (1312) can be determined based on the first offsets.

Referring to FIG. 13, the reference subpicture scaling window information of the reference subpicture (1301) can indicate dimension information and/or position information of the reference subpicture scaling window (1302). In an example, the reference subpicture scaling window information of the reference subpicture (1301) includes second offsets including a reference left offset O_{REF,L}, a reference right offset O_{REF,R}, a reference top offset O_{REF,T}, and a reference bottom offset O_{REF,B} of the reference subpicture scaling window (1302) with respect to the reference subpicture (1301). The dimension and the position of the reference subpicture scaling window (1302) can be determined based on the second offsets.

According to an embodiment of the disclosure, subpicture scaling window information of a subpicture scaling window of a subpicture can be signaled when more than one subpicture is present, for example, in a picture. The subpicture scaling window information can be signaled. The subpicture scaling window information can be signaled in a syntax structure (e.g., a high-level syntax structure), such as a high-level syntax structure (e.g., a PPS) within the CVS. In an example, subpicture scaling window information of a subpicture scaling window of each subpicture can be signaled. For subpicture-wise reference picture resampling in a layer or across layers, subpicture scaling window information for each subpicture that has a different scaling ratio with a respective reference subpicture can be signaled, for example, in a high-level syntax structure (e.g., a PPS).

A layout of a video can be customized. A number of players can play simultaneously in a collaborative and interactive game. At the same time, multiple audiences can follow the game in a real-time. An observer may watch a combination of views from favorable players, observer views, and/or physical camera views, for example, according to certain selection criteria. In some examples, a server may generate and transmit multiple layouts of multiple input videos depending on director's cuts. The layout information can be represented by subpicture partitioning information, such as in an SPS, or additionally delivered as metadata in file format. When each audience member chooses one of the layouts by a preference, or additionally customizes the layout due to the preference, a local region (e.g., each local region) of the decoded picture can be relocated in the displayed picture depending to the selected layout information. After decoding and reorganizing the main video and one or more enhanced videos, the customized video can be created, for example, in the cloud. Such a reorganization process for the customization of video may be processed in a cloud server, for example, with network-based media processing (NBMP). The combined video can be streamed to a client. The layout information can be generated by a user or a client. The layout information can be shared with other users to enjoy the same experience.

In some examples, each local region can be mapped to a respective subpicture. A subpicture layout can be signaled in an SPS. In certain video coding standards (e.g., VVC version 1), the subpicture layout can be updated only at the start of a CVS. In some embodiments, the same subpicture layout is applied to the entire CVS. For example, the subpicture layout is not updated within the CVS. Flexible layout representation for game and E-sports content composition may be limited in some applications as the same subpicture layout is used within the same CVS.

To enable more flexible composition of output images or pictures within a CVS, an instant update of a subpicture layout can be desirable. According to an embodiment of the disclosure, subpicture layout information (or subpicture partition information) indicating a subpicture layout (or a subpicture partitioning layout) in a picture can be updated within a CVS. Updating subpicture partition information can be applied in various applications, such as gaming, E-Sport, immersive media, and/or the like.

A subpicture layout (or a subpicture partitioning layout) can be signaled. For example, the subpicture layout can be indicated by subpicture partitioning information in a high-level syntax structure that applies to picture(s) within a CVS. The subpicture partitioning information or the subpicture layout can indicate position(s), spatial resolution(s), and/or subpictures ID(s) of subpicture(s) in the picture(s) within the CVS. The subpicture layout can be updated (e.g., changed) within the CVS. For example, a first subset of pictures in the CVS covered by a first syntax structure (e.g., a first high-level syntax structure) has a first subpicture layout. The first subpicture layout is specified by first subpicture partitioning information in the first high-level syntax structure. A second subset of pictures in the CVS covered by a second syntax structure (e.g., a second high-level syntax structure) has a second subpicture layout. The second subpicture layout is specified by second subpicture partitioning information in the second high-level syntax structure.

In an example, the first subpicture layout is different from the second subpicture layout. A first number of subpictures in the first subpicture layout can be different from a second number of subpictures in the second subpicture layout. In an example, a subpicture in the first subpicture layout is not included in the second subpicture layout. Two subpictures having a same subpicture ID in the first subpicture layout and the second subpicture layout can have different spatial resolutions and/or positions.

In an example, the first subpicture layout is identical to the second subpicture layout.

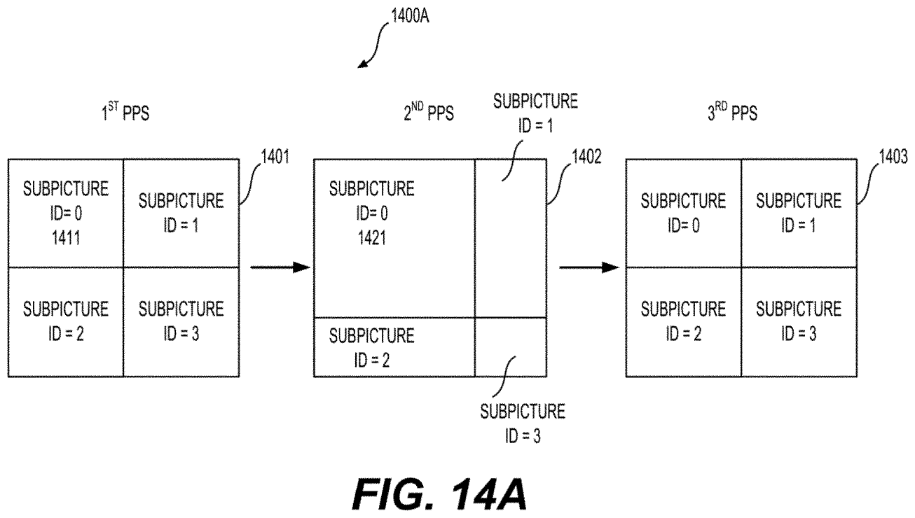

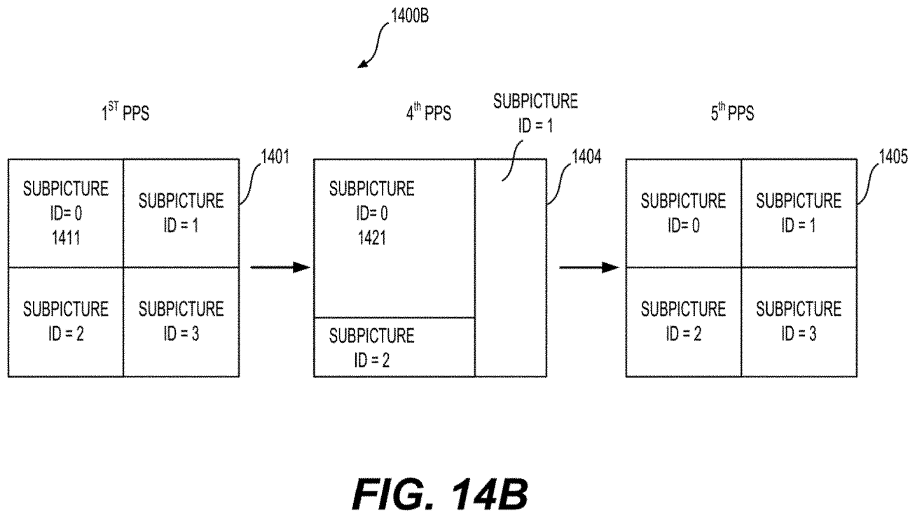

FIG. 14A shows an exemplary subpicture layout update process (1400A) within a CVS according to an embodiment of the disclosure.

A subpicture layout (1401) can be indicated (e.g., specified) by first subpicture partitioning information in a first PPS (e.g., an PPS ID being 0). The first subpicture partitioning information or the subpicture layout (1401) can indicate position(s), spatial resolution(s), and/or subpictures ID(s) of subpicture(s) in one or more pictures in the first PPS. The subpicture IDs of subpictures in the subpicture layout (1401) are 0-3, respectively, and the subpictures are referred to as the subpictures 0-3.

The subpicture layer (1401) can be updated to a subpicture layout (1402) by a second PPS. The subpicture layout (1402) can be indicated (e.g., specified) by second subpicture partitioning information in the second PPS (e.g., an PPS ID being 1). The second subpicture partitioning information or the subpicture layout (1402) can indicate position(s), spatial resolution(s), and/or subpictures ID(s) of subpicture(s) in one or more pictures in the second PPS. The subpicture IDs of subpictures in the subpicture layout (1402) are the subpictures 0-3. The subpicture layout (1402) is different from the subpicture layout (1401). For example, the spatial resolutions of the subpictures 0-3 in the subpicture layout (1402) are different from the respective spatial resolutions of the subpictures 0-3 in the subpicture layout (1401). The spatial resolution of the subpictures 0 (1421) in the subpicture layout (1402) is higher than the spatial resolution of the subpictures 0 (1411) in the subpicture layout (1401).

The subpicture layer (1402) can be updated to a subpicture layout (1403) by a third PPS, similar as described above. The subpicture IDs of subpictures in the subpicture layout (1403) are the subpictures 0-3. The third PPS can be different from the second PPS and/or the first PPS. In an example, the subpicture layout (1403) is different from the subpicture layout (1402). In an example, the subpicture layout (1403) is identical to a previous subpicture layout used in the CVS, such as the subpicture layout (1401). In an example, the PPS ID of the third PPS is 2. In an example, the PPS ID of the third PPS is 0.

The subpicture layout update process (1400A) can be performed within a CVS. A subpicture layout (e.g., indicated by a first syntax structure, such as a first PPS)) of a picture in the CVS can be updated to generate a different subpicture layout (e.g., indicated by a second syntax structure, such as a second PPS) of another picture in the CVS.

The subpicture layout update process (1400A) performed within a CVS can enable a composition layout change without delay or coding gain loss. By signaling a subpicture layout and/or subpicture ID mapping information, such as within a CVS (e.g., in a PPS), the subpicture layout can be updated in at a picture-level. To minimize coding efficiency loss when the subpicture layout is updated or changed, motion compensated prediction can be enabled within the same subpicture, for example, with a subpicture-specific scaling window, such as described in FIG. 13.

In an embodiment, updated subpicture partitioning information can be signaled in a PPS. To enable a picture-level update of subpicture partitioning information, the subpicture partitioning information can be signaled in a PPS, optionally. When the subpicture partitioning information is updated, one or more subpictures with respective subpicture IDs may appear or disappear. FIG. 14B shows an exemplary subpicture layout update process (1400B) within a CVS according to an embodiment of the disclosure. The subpicture layout (1401) indicated by the first PPS and the subpictures 0-3 in FIG. 14B are described in FIG. 14A.

In the subpicture layout update process (1400B), the subpicture layer (1401) is updated by a fourth PPS into a subpicture layout (1404). The subpicture layout (1404) can be indicated (e.g., specified) by fourth subpicture partitioning information in the fourth PPS (e.g., an PPS ID being 3). The fourth subpicture partitioning information or the subpicture layout (1404) can indicate position(s), spatial resolution(s), and/or subpictures ID(s) of subpicture(s) in one or more pictures in the fourth PPS. The subpicture IDs of subpictures in the subpicture layout (1404) are the subpictures 0-2. The subpicture layout (1404) is different from the subpicture layout (1401). For example, the spatial resolutions of the subpictures 0-2 in the subpicture layout (1404) are different from the respective spatial resolutions of the subpictures 0-2 in the subpicture layout (1401). Further, a number of the subpictures in the subpicture layout (1404) is 3, which is different from a number (e.g., 4) of the subpictures in the subpicture layout (1401). The subpicture 3 in the subpicture layout (1401) is not in the subpicture layout (1404). The subpicture 3 in the subpicture layout (1401) disappears from the subpicture layout (1404).

The subpicture layer (1404) is updated by a fifth PPS (e.g., an PPS ID being 4) into a subpicture layout (1405). In an example, the subpicture layout (1405) is identical to the subpicture layout (1401). The subpicture layout (1405) is different from the subpicture layout (1404). For example, the subpicture 3 that is not in the subpicture layout (1404) appears in the subpicture layout (1405).

When the subpicture partitioning information is updated, dimension information (e.g., spatial resolution(s)) and/or position information (e.g., vertical offset values, and/or horizontal offset values) of each subpicture may be changed.

In some examples of certain video coding technologies (e.g., VVC version 1), all layers belonging to a same dependency tree can have a same subpicture partitioning layout. According to an embodiment of the disclosure, the above constraint can be relaxed to support applications where different subpicture layouts can be applied across different layers. In an embodiment, a first subpicture layout of a first layer can be different from a second subpicture layout of a second layer. In an example, each layer has a different subpicture layout.

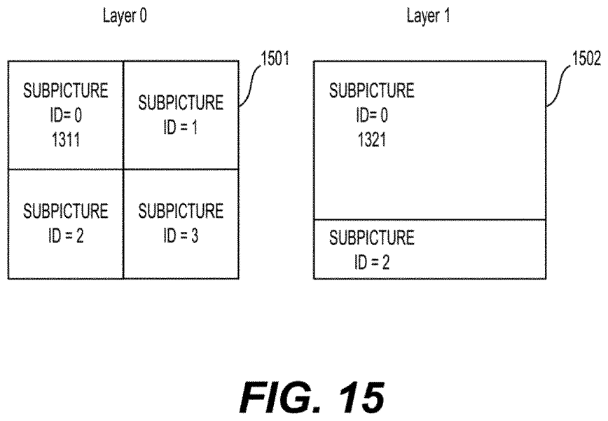

FIG. 15 shows exemplary subpicture layouts (1501) and (1502) in different layers in a CVS according to an embodiment of the disclosure. The subpicture layout (1501) and the subpictures 0-3 in the subpicture layout (1501) can be identical to the subpicture layout (1401) and the subpictures 0-3 described in FIG. 14A, respectively. The subpicture layout (1501) can apply to picture(s) in a layer 0 in the CVS. The subpicture layout (1502) can apply to picture(s) in a layer 1 in the CVS. The subpicture layout (1502) corresponding to the layer 1 is different from the subpicture layout (1501) corresponding to the layer 0. For example, the subpictures 1 and 3 disappear from the subpicture layout (1502). The subpictures 0 and 2 in the subpicture layout (1502) have different spatial resolutions from the subpictures 0 and 2 in the subpicture layout (1501), respectively.

In some examples of certain video coding technologies (e.g., VVC version 1), a combination of subpicture partitioning and reference picture resampling is not supported. According to an embodiment of the disclosure, the above constraint can be relaxed to support region-wise quality and resolution enhancement. In an embodiment, subpicture partitioning and subpicture-wise reference picture resampling can be combined. In an example, updating subpicture partitioning information within a CVS is combined with the subpicture-wise reference picture resampling. For example, subpicture partitioning information and subpicture scaling window information of a subpicture scaling window of a subpicture are signaled, for example in a high-level syntax structure, such as a PPS.

According to an embodiment of the disclosure, a syntax structure (e.g., a high-level syntax structure), such as a parameter set can include an extension, such as a subpicture reference picture resampling (RPR) extension to indicate (i) subpicture partitioning information and/or (ii) subpicture scaling window information of a subpicture scaling window of a subpicture. In an embodiment, the parameter set is a PPS, and the extension is referred to as a PPS subpicture RPR extension as shown below in Tables 1-2.

Table 1 shows a portion of an exemplary syntax structure of a PPS according to an embodiment of the disclosure.

TABLE 1
A portion of a syntax structure PPS

| | Descriptor |
|---|---|
| pic_parameter_set_rbsp( ) { | |
| ... | u(1) |
| pps_extension_flag | u(1) |
| if( pps_extension_flag ) | |
| pps_subpic_rpr_extension_flag | u(1) |
| pps_extension_7bits | u(7) |
| } | |
| if( pps_subpic_rpr_extension_flag ) | |
| pps_ subpic_rpr_extension( ) | |
| if( pps_extension_7bits ) | |
| while( more_rbsp_data( ) ) | |
| pps_extension_data_flag | u(1) |
| rbsp_trailing_bits( ) | |
| } | |

Table 2 shows an exemplary syntax structure extension of a PPS according to an embodiment of the disclosure.

TABLE 2
An example of a picture parameter set subpicture
and reference picture resampling syntax

| | Descriptor |
|---|---|
| pps_subpic_rpr_extension( ){ | |
| pps_subpic_update_info_present_flag | u(1) |
| pps_subpic_scaling_win_info_present_flag | u(1) |
| if( pps_subpic_update_info_present_flag \|\| | |
| pps_subpic_scaling_win_info_present_flag ) | |
| pps_updated_num_subpics_minus1 | ue(v) |
| if( pps_subpic_update_info_present_flag ) { | |
| if( pps_updated_num_subpics_minus1 > 0 ) { | |
| pps_independent_subpics_flag | u(1) |
| pps_subpic_same_size_flag | u(1) |
| } | |
| for( i = 0; pps_updated_num_subpics_minus1 > 0 && i <= pps_{—} | |
| updated_num_subpics_minus1; i++ ) { | |
| if( !pps_subpic_same_size_flag \| \| i = = 0 ) { | |
| if( i > 0 && pps_pic_width_in_luma_samples > CtbSizeY ) | |
| pps_subpic_ctu_top_left_x[ i ] | u(v) |
| if( i > 0 && pps_pic_height_in_luma_samples > CtbSizeY ) | |
| pps_subpic_ctu_top_left_y[ i ] | u(v) |
| if( i < pps_updated_num_subpics_minus1 && | |
| pps_pic_width_in_luma_samples > CtbSizeY ) | |
| pps_subpic_width_minus1[ i ] | u(v) |
| if( i < pps_updated_num_subpics_minus1 && | |
| pps_pic_height_in_luma_samples > CtbSizeY ) | |
| pps_subpic_height_minus1[ i ] | u(v) |
| } | |
| if( !pps_independent_subpics_flag) { | |
| pps_subpic_treated_as_pic_flag[ i ] | u(1) |
| pps_loop_filter_across_subpic_enabled_flag[ i ] | u(1) |
| } | |
| } | |
| pps_updated_subpic_id_len_minus1 | ue(v) |
| pps_updated_subpic_id_mapping_explicitly_signalled_flag | u(1) |
| if( pps_updated_subpic_id_mapping_explicitly_signalled_flag ) { | |
| pps_updated_subpic_id_mapping_present_flag | u(1) |
| if( pps_updated_subpic_id_mapping_present_flag ) | |
| for( i = 0; i <= pps_updated_num_subpics_minus1; i++ ) | |
| pps_updated_subpic_id[ i ] | u(v) |
| } | |
| } | |
| if( pps_subpic_scaling_win_info_present_flag ) { | |
| for( i = 0; i <= pps_updated_num_subpics_minus1; i++ ) { | |
| pps_subpic_scaling_win_left_offset[ i ] | se(v) |
| pps_subpic_scaling_win_right_offset[ i ] | se(v) |
| pps_subpic_scaling_win_top_offset[ i ] | se(v) |
| pps_subpic_scaling_win_bottom_offset[ i ] | se(v) |
| } | |
| } | |
| } | |

A syntax element, such as a flag (e.g., pps_subpic_rpr_extension_flag) can indicate whether a PPS subpicture RPR extension (e.g., pps_subpic_rpr_extension( ) syntax structure in Table 2) is present in a PPS RBSP syntax structure. The syntax element (e.g., pps_subpic_rpr_extension_flag) equal to 1 can specify that the pps_subpic_rpr_extension( ) syntax structure is present in the PPS RBSP syntax structure. The syntax element (e.g., pps_subpic_rpr_extension_flag) equal to 0 can specify that the pps_subpic_rpr_extension( ) syntax structure is not present. When not present, the value of the syntax element (e.g., pps_subpic_rpr_extension_flag) can be inferred to be equal to 0.

When the syntax element (e.g., pps_subpic_rpr_extension_flag) is equal to 1, the pps_subpic_rpr_extension( ) syntax structure is present in the PPS RBSP syntax structure.

Table 2 shows an exemplary PPS RBSP syntax structure. Referring to Table 2, a first syntax element, such as a first flag pps_subpic_update_info_present_flag, can indicate whether subpicture partitioning information (or subpicture partitioning layout information) is present in the PPS. The first syntax element (e.g., pps_subpic_update_info_present_flag) equal to 1 can specify that the subpicture partitioning layout information is present (e.g., is signaled) in the PPS. The first syntax element (e.g., pps_subpic_update_info_present_flag) equal to 0 can specify that the subpicture partitioning layout information is not present in the PPS.

A second syntax element, such as a second flag pps_subpic_scaling_win_info_present_flag can indicate whether subpicture-wise scaling window information is present (e.g., is signaled) in the PPS. The second syntax element (e.g., pps_subpic_scaling_win_info_present_flag) equal to 1 can specify that the subpicture-wise scaling window information is present in the PPS. The second syntax element (e.g., pps_subpic_scaling_win_info_present_flag) equal to 0 can specify that the subpicture-wise scaling window information is not present in the PPS.

A syntax element pps_updated_num_subpics_minus1 plus 1 can specify the number of subpictures of each picture that refers to the PPS. The value of pps_updated_num_subpics_minus1 can be in the range of 0 to MaxSlicesPerAu−1, inclusive. In an example, MaxSlicesPerAu indicates a maximum number of slices per AU. When not present, the value of pps_updated_num_subpics_minus1 is inferred to be equal to sps_num_subpics_minus1.

A syntax element pps_independent_subpics_flag equal to 1 can specify that all subpicture boundaries of each picture that refers to the PPS are treated as picture boundaries and there is no loop filtering across the subpicture boundaries. The syntax element pps_independent_subpics_flag equal to 0 does not impose such a constraint. When not present, the value of pps_independent_subpics_flag is inferred to be equal to 1.

A syntax element pps_subpic_same_size_flag equal to 1 can specify that all subpictures of each picture that refers to the PPS have the same width specified by pps_subpic_width_minus1[0] and the same height specified by pps_subpic_height_minus1[0]. The syntax element pps_subpic_same_size_flag equal to 0 does not impose such a constraint. When not present, the value of pps_subpic_same_size_flag is inferred to be equal to 0.

In an example, the variable tmpWidthVal is equal to (pps_pic_width_in_luma_samples+CtbSizeY−1)/CtbSizeY, and the variable tmpHeightVal is equal to (pps_pic_height_in_luma_samples+CtbSizeY−1)/CtbSizeY.

A syntax element pps_subpic_ctu_top_left_x[i] can specify a horizontal position of a top-left CTU of i-th subpicture in unit of CtbSizeY. The length of the syntax element is Ceil(Log 2(tmpWidthVal)) bits.

When not present, the value of pps_subpic_ctu_top_left_x[i] can be inferred as follows:
If pps_subpic_same_size_flag is equal to 0 or i is equal to 0, the value of pps_subpic_ctu_top_left_x[i] is inferred to be equal to 0.—
Otherwise, the value of pps_subpic_ctu_top_left_x[i] is inferred to be equal to (i % numSubpicCols)*(pps_subpic_width_minus1[0]+1).

When pps_subpic_same_size_flag is equal to 1, the variable numSubpicCols, specifying the number of subpicture columns in each picture in the CLVS, is derived as follows: numSubpicCols=tmpWidthVal/(pps_subpic_width_minus1[0]+1).

When pps_subpic_same_size_flag is equal to 1, the value of numSubpicCols*tmpHeightVal/(pps_subpic_height_minus1[0]+1)−1 can be equal to pps_updated_num_subpics_minus1.

A syntax element pps_subpic_ctu_top_left_y[i] can specify a vertical position of the top-left CTU of the i-th subpicture in unit of CtbSizeY. The length of the syntax element is Ceil(Log 2(tmpHeightVal)) bits.

When not present, the value of pps_subpic_ctu_top_left_y[i] can be inferred as follows:
If pps_subpic_same_size_flag is equal to 0 or i is equal to 0, the value of pps_subpic_ctu_top_left_y[i] is inferred to be equal to 0.—
Otherwise, the value of pps_subpic_ctu_top_left_y[i] is inferred to be equal to (i/numSubpicCols)*(pps_subpic_height_minus1[0]+1).

A syntax element pps_subpic_width_minus1 [i] plus 1 can specify the width of the i-th subpicture in units of CtbSizeY. The length of the syntax element is Ceil(Log 2(tmpWidthVal)) bits.

When not present, the value of pps_subpic_width_minus1[i] is inferred as follows:
If pps_subpic_same_size_flag is equal to 0 or i is equal to 0, the value of pps_subpic_width_minus1[i] is inferred to be equal to tmpWidthVal−pps_subpic_ctu_top_left_x[i]−1.
Otherwise, the value of pps_subpic_width_minus1 [i] is inferred to be equal to pps_subpic_width_minus1[0].

When pps_subpic_same_size_flag is equal to 1, the value of tmpWidthVal % (pps_subpic_width_minus1[0]+1) can be equal to 0.

A syntax element pps_subpic_height_minus1 [i] plus 1 can specify the height of the i-th subpicture in units of CtbSizeY. The length of the syntax element is Ceil(Log 2(tmpHeightVal)) bits.

When not present, the value of pps_subpic_height_minus1[i] can be inferred as follows:
If pps_subpic_same_size_flag is equal to 0 or i is equal to 0, the value of pps_subpic_height_minus1 [i] is inferred to be equal to tmpHeightVal−pps_subpic_ctu_top_left_y[i]−1.
Otherwise, the value of pps_subpic_height_minus1 [i] is inferred to be equal to pps_subpic_height_minus1[0].

When pps_subpic_same_size_flag is equal to 1, the value of tmpHeightVal % (pps_subpic_height_minus1[0]+1) shall be equal to 0.

In an example, it is a requirement of bitstream conformance that the shapes of the subpictures can be such that each subpicture, when decoded, can have its entire left boundary and entire top boundary including picture boundaries or including boundaries of previously decoded subpictures.

In an example, for each subpicture with subpicture index i in the range of 0 to pps_num_subpics_minus1, inclusive, it is a requirement of bitstream conformance that all of the following conditions are true:
The value of (pps_subpic_ctu_top_left_x[i]*CtbSizeY) shall be less than (pps_pic_width_in_luma_samples−pps_conf_win_right_offset*SubWidthC).
The value of ((pps_subpic_ctu_top_left_x[i]+pps_subpic_width_minus1 [i]+1)*CtbSizeY) shall be greater than (pps_conf_win_left_offset*SubWidthC).
The value of (pps_subpic_ctu_top_left_y[i]*CtbSizeY) shall be less than (pps_pic_height_in_luma_samples—pps_conf_win_bottom_offset*SubHeightC).
The value of ((pps_subpic_ctu_top_left_y[i]+pps_subpic_height_minus1 [i]+1)*CtbSizeY) shall be greater than (pps_conf_win_top_offset*SubHeightC).

A syntax element pps_subpic_treated_aspic_flag[i] equal to 1 can specify that the i-th subpicture of each coded picture that refers to the PPS is treated as a picture in the decoding process excluding in-loop filtering operations. pps_subpic_treated_aspic_flag[i] equal to 0 can specify that the i-th subpicture of each coded picture in the CLVS is not treated as a picture in the decoding process excluding in-loop filtering operations. When not present, the value of pps_subpic_treated_aspic_flag[i] is inferred to be equal to 1.

A syntax element pps_loop_filter_across_subpic_enabled_flag[i] equal to 1 can specify that in-loop filtering operations across subpicture boundaries is enabled and may be performed across the boundaries of the i-th subpicture in each coded picture in the CLVS. pps_loop_filter_across_subpic_enabled_flag[i] equal to 0 can specify that in-loop filtering operations across subpicture boundaries is disabled and are not performed across the boundaries of the i-th subpicture in each coded picture in the CLVS. When not present, the value of pps_loop_filter_across_subpic_enabled_pic_flag[i] is inferred to be equal to 0.

A syntax element pps_updated_subpic_id_len_minus1 plus 1 can specify the number of bits used to represent the syntax element pps_updated_subpic_id[i], when present, and optionally the syntax element sh_subpic_id, when present. The value of pps_updated_subpic_id_len_minus1 can be in the range of 0 to 15, inclusive. The value of 1<<(pps_updated_subpic_id_len_minus1+1) can be greater than or equal to pps_updated_num_subpics_minus1+1.

A syntax element pps_updated_subpic_id mapping explicitly signalled flag equal to 1 can specify that the subpicture ID mapping is explicitly signaled, in the PPSs referred to by coded pictures of the CLVS. pps_updated_subpic_id mapping explicitly signalled flag equal to 0 can specify that the subpicture ID mapping is not explicitly signaled for the CLVS. When not present, the value of pps_updated_subpic_id mapping explicitly signalled flag is inferred to be equal to 0.

A syntax element pps_updated_subpic_id_mapping_present_flag equal to 1 can specify that the subpicture ID mapping is signaled in the PPS when pps_updated_subpic_id mapping explicitly signalled flag is equal to 1. pps_updated_subpic_id_mapping_present_flag equal to 0 can specify that subpicture ID mapping is signaled in the PPSs referred to by coded pictures of the CLVS when pps_subpic_id_mapping_explicitly_signalled_flag is equal to 1.

A syntax element pps_updated_subpic_id[i] can specify the subpicture ID of the i-th subpicture. The length of the pps_updated_subpic_id[i] syntax element is pps_updated_subpic_id_len_minus1+1 bits.

Syntax elements pps_subpic_scaling_win_left_offset[i], pps_subpic_scaling_win_right_offset[i], pps_subpic_scaling_win_top_offset[i], and pps_subpic_scaling_win_bottom_offset[i] can specify the offsets that are applied to the subpicture size of the i-th subpicture for scaling ratio calculation. Referring to FIG. 13, the syntax elements pps_subpic_scaling_win_left_offset[i], pps_subpic_scaling_win_right_offset[i], pps_subpic_scaling_win_top_offset[i], and pps_subpic_scaling_win_bottom_offset[i] can specify the left offset O_{L}, the right offset O_{R}, the top offset O_{T}, and the bottom offset OB of the subpicture scaling window (1312) with respect to the subpicture (1311), respectively.

When not present, the values of pps_subpic_scaling_win_left_offset[i], pps_subpic_scaling_win_right_offset[i], pps_subpic_scaling_win_top_offset[i], and pps_subpic_scaling_win_bottom_offset[i] are inferred to be equal to pps_scaling_win_left_offset, pps_scaling_win_right_offset, pps_scaling_win_top_offset, and pps_scaling_win_bottom_offset, respectively.

Depending on the values of the first syntax element (or the first flag) and the second syntax element (or the second flag) in the syntax structure (e.g., the high-level syntax structure), such as the PPS in Table 2, various operations can be performed.

In an embodiment, the first flag indicates that the subpicture partitioning layout information for a picture is signaled. For example, the first flag indicates the subpicture partitioning layout information is signaled in the PPS, for example, when the first flag (e.g., pps_subpic_update_info_present_flag) is equal to 1. In an example, the picture includes a plurality of subpictures. Based on the subpicture partitioning information (e.g., the syntax elements pps_subpic_ctu_top_left_x[i], pps_subpic_ctu_top_left_y[i], pps_subpic_width_minus1 [i], and pps_subpic_height_minus1 [i]), a subpicture layout of the plurality of subpictures in the picture including a size (e.g., a width W of a subpicture indicated by the syntax element pps_subpic_width_minus1[i] and a height H of a subpicture indicated by pps_subpic_height_minus1 [i]) and a position (e.g., indicated by the syntax elements pps_subpic_ctu_top_left_x[i] and pps_subpic_ctu_top_left_y[i]) of each of the plurality of subpictures in the picture can be determined. In an example, a subpicture identifier (ID) of each subpicture in the picture is determined based on the subpicture partitioning information (e.g., the syntax element pps_updated_subpic_id[i]) in the PPS. A first subpicture in the plurality of subpictures can be reconstructed based on the subpicture partitioning information, such as the size and the position of the first subpicture. The subpicture partitioning layout information can be updated within the CVS, for example, from a picture that refers to a first PPS to another picture that refers to a second PPS.

In an example, first subpicture partitioning information is signaled in a first PPS, and second subpicture partitioning information is signaled in a second PPS. A second subpicture layout indicated by the second subpicture partitioning information is different from a first subpicture layout indicated by the first subpicture partitioning information.

In an embodiment, the second flag indicates that the subpicture scaling window information for a subpicture is signaled. For example, the second flag indicates that the subpicture scaling window information is signaled in the PPS, for example, when the second syntax element (e.g., pps_subpic_scaling_win_info_present_flag) is equal to 1. A reference subpicture of the subpicture can have a different spatial resolution (or a different size) from a spatial resolution of the subpicture.

In an example, the subpicture scaling window information of the subpicture (e.g., the syntax elements pps_subpic_scaling_win_left_offset[i], pps_subpic_scaling_win_right_offset[i], pps_subpic_scaling_win_top_offset[i], and pps_subpic_scaling_win_bottom_offset[i] in Table 2) is decoded from the PPS. The subpicture can be reconstructed using subpicture-wise reference picture resampling that is based on the subpicture scaling window information of the subpicture.

For example, the syntax elements pps_subpic_scaling_win_left_offset[i], pps_subpic_scaling_win_right_offset[i], pps_subpic_scaling_win_top_offset[i], and pps_subpic_scaling_win_bottom_offset[i] indicate the first offsets, such as the left offset O_{L}, the right offset O_{R}, the top offset O_{T}, and the bottom offset OB of the subpicture scaling window (1312). In an example, a width W_{S} of the subpicture scaling window (1312) is determined as W_{S}=W−(O_{L}+O_{R}) where W is a width of the subpicture. In an example, a height Hs of the subpicture scaling window (1312) is determined as H_{S}=H−(O_{T}+O_{B}) where H is a height of the subpicture.

A scaling ratio associated with the reference subpicture (1301) and the subpicture (1311) can be determined based on dimension information of a scaling window (e.g., 1312) of the subpicture (1311). Referring to FIG. 13, the scaling ratio between the reference subpicture (1301) and the subpicture (1311) can be determined based on the width Ws of the subpicture scaling window (1312) and the height Hs of the subpicture scaling window (1312). The subpicture-wise reference picture resampling can be performed based on the determined scaling ratio associated with the reference subpicture (1301) and the subpicture (1311). In an example, a scaled reference subpicture that matches the spatial resolution (or a size) of the subpicture is generated using the subpicture-wise reference picture resampling. The subpicture can be decoded with the scaled reference subpicture.

According to an embodiment, syntax elements indicating the subpicture partitioning information and the subpicture scaling window information can be combined in a syntax structure (e.g., a high-level syntax structure), such as a PPS.

In an embodiment, the first flag indicates that the subpicture partitioning information is signaled in the PPS. The second flag indicates that the subpicture scaling window information for the subpicture is signaled in the PPS. The subpicture partitioning information can be decoded based on the PPS. The subpicture scaling window information of the subpicture can be decoded based on the PPS. The dimension information (e.g., the width W indicated by pps_subpic_width_minus1 [i] and the height H indicated by pps_subpic_height_minus1[i]) and position information (e.g., indicated by pps_subpic_ctu_top_left_x[i] and pps_subpic_ctu_top_left_y[i]) of the subpicture can be determined based on the subpicture partitioning information, as described above. The subpicture can be reconstructed based on the subpicture scaling window information (e.g., indicated by pps_subpic_scaling_win_left_offset[i], pps_subpic_scaling_win_right_offset[i], pps_subpic_scaling_win_top_offset[i], and pps_subpic_scaling_win_bottom_offset[i]) of the subpicture, the dimension information of the subpicture, and the position information of the subpicture, as described above with reference to FIG. 13.

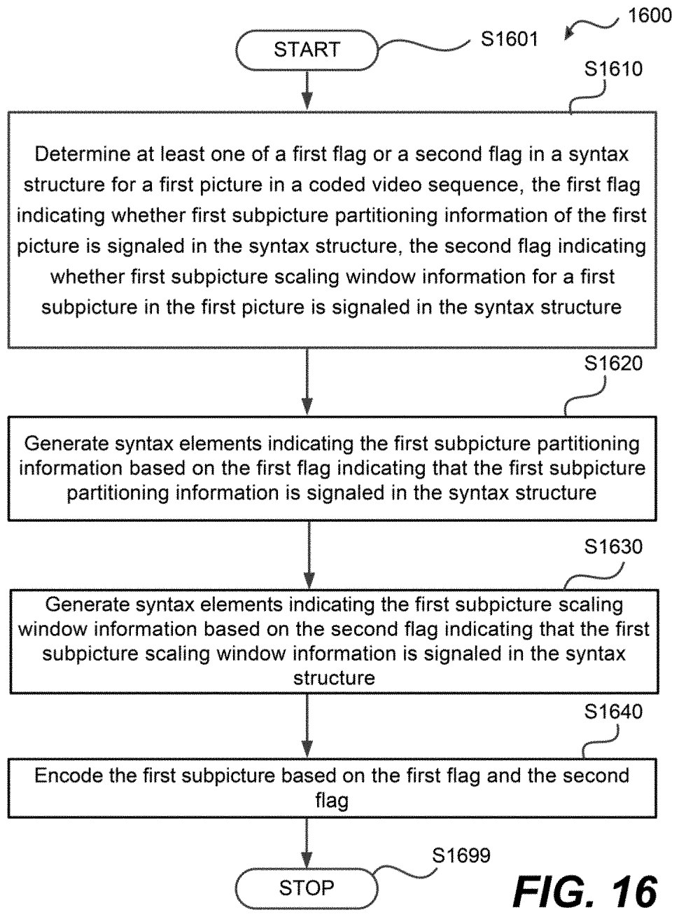

FIG. 16 shows a flow chart outlining an encoding process (1600) according to an embodiment of the disclosure. In various embodiments, the process (1600) is executed by processing circuitry, such as the processing circuitry in the terminal devices (310), (320), (330) and (340), processing circuitry that performs functions of a video encoder (e.g., (403), (603), (703)), or the like. In some embodiments, the process (1600) is implemented in software instructions, thus when the processing circuitry executes the software instructions, the processing circuitry performs the process (1600). The process starts at (S1601), and proceeds to (S1610).

At (S1610), at least one of a first flag or a second flag in a syntax structure (e.g., a high-level syntax structure) for a first picture in a coded video sequence can be determined. The first flag can indicate whether first subpicture partitioning information of the first picture is signaled in the syntax structure. The second flag can indicate whether first subpicture scaling window information for a first subpicture in the first picture is signaled in the syntax structure. In an example, the syntax structure is a PPS, such as shown in Table 2. The first flag can be the first syntax element (e.g., pps_subpic_update_info_present_flag). The second flag can be the second syntax element (e.g., pps_subpic_scaling_win_info_present_flag).

At (S1620), syntax elements indicating the first subpicture partitioning information can be generated based on the first flag indicating that the first subpicture partitioning information is signaled in the syntax structure. In an example, the first flag indicates that the first subpicture partitioning information is signaled in the syntax structure, for example, a value of the pps_subpic_update_info_present_flag being 1. The syntax elements indicating the first subpicture partitioning information, such as syntax elements indicating size(s), position(s), subpicture ID(s) of subpictures in the first picture can be generated.

At (S1630), syntax elements indicating the first subpicture scaling window information can be generated based on the second flag indicating that the first subpicture scaling window information is signaled in the syntax structure. In an example, the second flag indicates that the first subpicture scaling window information is signaled in the syntax structure, for example, a value of the pps_subpic_scaling_win_info_present_flag being 1. The syntax elements indicating the first subpicture scaling window information, such as syntax elements indicating offsets of subpictures in the first picture can be generated.

At (S1640), the first subpicture can be encoded based on the first flag and the second flag. If the first flag indicates that the first subpicture partitioning information is signaled in the syntax structure, the first subpicture can be encoded based on the first subpicture partitioning information.

If the second flag indicates that the first subpicture scaling window information is signaled in the syntax structure, the first subpicture can be encoded based on the first subpicture scaling window information.

If the first flag indicates that the first subpicture partitioning information is signaled in the syntax structure and the second flag indicates that the first subpicture scaling window information is signaled in the syntax structure, the first subpicture can be encoded based on the first subpicture partitioning information and the first subpicture scaling window information.

The process (1600) can be suitably adapted to various scenarios and steps in the process (1600) can be adjusted accordingly. One or more of the steps in the process (1600) can be adapted, omitted, repeated, and/or combined. Any suitable order can be used to implement the process (1600). Additional step(s) can be added.

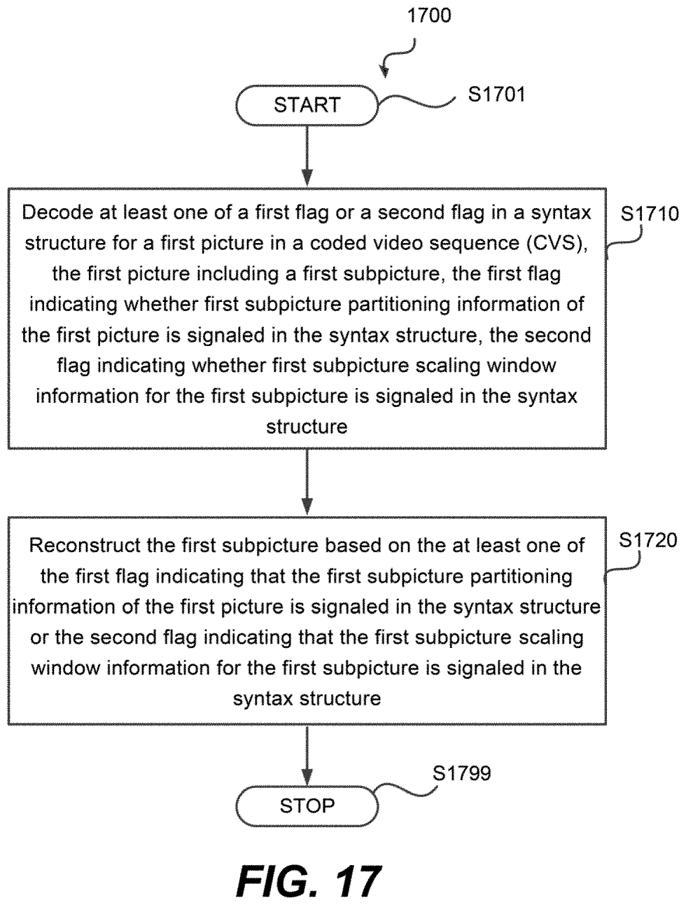

FIG. 17 shows a flow chart outlining a decoding process (1700) according to an embodiment of the disclosure. In various embodiments, the process (1700) is executed by processing circuitry, such as the processing circuitry in the terminal devices (310), (320), (330) and (340), the processing circuitry that performs functions of the video encoder (403), the processing circuitry that performs functions of the video decoder (410), the processing circuitry that performs functions of the video decoder (510), the processing circuitry that performs functions of the video encoder (603), and the like. In some embodiments, the process (1700) is implemented in software instructions, thus when the processing circuitry executes the software instructions, the processing circuitry performs the process (1700). The process starts at (S1701), and proceeds to (S1710).

At (S1710), at least one of a first flag (e.g., pps_subpic_update_info_present_flag) or a second flag (e.g., pps_subpic_scaling_win_info_present_flag) in a syntax structure (e.g., a high-level syntax structure) for a first picture in a coded video sequence (CVS) can be decoded. The first picture can include a first subpicture. The first flag can indicate whether first subpicture partitioning information of the first picture is signaled in the syntax structure. The second flag can indicate whether first subpicture scaling window information for the first subpicture is signaled in the syntax structure. In an embodiment, the syntax element is the high-level syntax structure.

In an example, the syntax structure is a first picture parameter set (PPS) syntax structure.

At (S1720), the first subpicture can be reconstructed based on (i) the first flag indicating that the first subpicture partitioning information is signaled in the syntax structure or (ii) the second flag indicating that the first subpicture scaling window information for the first subpicture is signaled in the syntax structure.

In an example, the at least one of the first flag and the second flag includes the first flag. The first flag indicates that the first subpicture partitioning information for the first picture is signaled in the syntax structure.

The first picture includes a plurality of subpictures where the plurality of subpictures includes the first subpicture. Based on the first subpicture partitioning information, a first subpicture layout of the plurality of subpictures in the first picture can be determined. The first subpicture layout can indicate (e.g., include) a size and a position of each of the plurality of subpictures in the first picture, such as described with reference to Table 2.

A subpicture identifier (ID) of each subpicture in the first picture can be determined based on the first subpicture partitioning information in the syntax structure.

In an example, the syntax structure that includes the first subpicture partitioning information is a first PPS. Second subpicture partitioning information signaled in a second PPS syntax structure for a second picture in the CVS can be decoded. Second subpictures in the second picture can be reconstructed based on the second subpicture partitioning information. A second subpicture layout of the second picture can be different from the first subpicture layout of the first picture.

The at least one of the first flag and the second flag can include the second flag. The second flag can indicate that the first subpicture scaling window information of the first subpicture is signaled in the syntax structure. The first subpicture scaling window information of the first subpicture can be decoded based on the syntax structure. The first subpicture can be reconstructed using subpicture-wise reference picture resampling that is based on the first subpicture scaling window information of the first subpicture.

The process (1700) proceeds to (S1799), and terminates.

The process (1700) can be suitably adapted to various scenarios and steps in the process (1700) can be adjusted accordingly. One or more of the steps in the process (1700) can be adapted, omitted, repeated, and/or combined. Any suitable order can be used to implement the process (1700). Additional step(s) can be added.

In an example, the first picture is in a first layer in the CVS. Second subpicture partitioning information signaled in another syntax structure for a second picture in a second layer in the CVS can be decoded. The second subpicture partitioning information can be different from the first subpicture partitioning information. Second subpictures in the second picture can be reconstructed based on the second subpicture partitioning information.

In an embodiment, the at least one of the first flag and the second flag includes the first flag and the second flag. The first flag indicates that the first subpicture partitioning information is signaled in the syntax structure. The second flag can indicate that the first subpicture scaling window information of the first subpicture is signaled in the syntax structure. The first subpicture scaling window information of the first subpicture can be decoded from the syntax structure. Dimension information and position information of the first subpicture can be determined based on the first subpicture partitioning information. The first subpicture can be reconstructed based on the first subpicture scaling window information of the first subpicture, the dimension information of the first subpicture, and the position information of the first subpicture.

Embodiments in the disclosure may be used separately or combined in any order. Further, each of the methods (or embodiments), an encoder, and a decoder may be implemented by processing circuitry (e.g., one or more processors or one or more integrated circuits). In one example, the one or more processors execute a program that is stored in a non-transitory computer-readable medium.

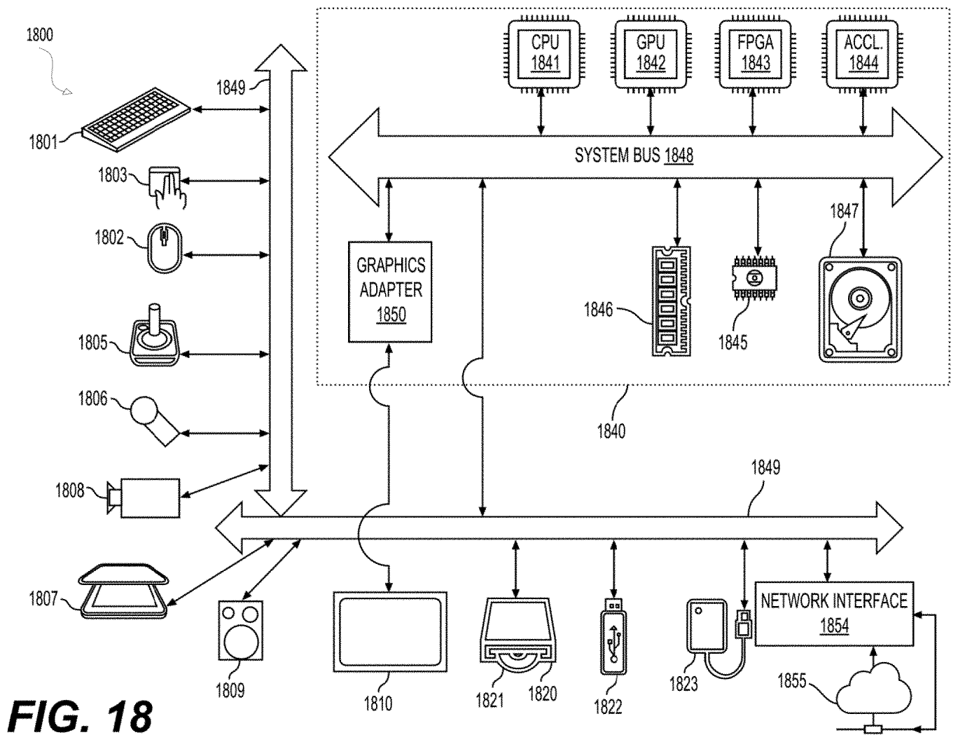

The techniques described above, can be implemented as computer software using computer-readable instructions and physically stored in one or more computer-readable media. For example, FIG. 18 shows a computer system (1800) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 18 for computer system (1800) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1800).

Computer system (1800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1801), mouse (1802), trackpad (1803), touch screen (1810), data-glove (not shown), joystick (1805), microphone (1806), scanner (1807), camera (1808).

Computer system (1800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1810), data-glove (not shown), or joystick (1805), but there can also be tactile feedback devices that do not serve as input devices), audio output devices (such as: speakers (1809), headphones (not depicted)), visual output devices (such as screens (1810) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1800) can also include human accessible storage devices and their associated media such as optical media including CD/DVD ROM/RW (1820) with CD/DVD or the like media (1821), thumb-drive (1822), removable hard drive or solid state drive (1823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1800) can also include an interface (1854) to one or more communication networks (1855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1849) (such as, for example USB ports of the computer system (1800)); others are commonly integrated into the core of the computer system (1800) by attachment to a system bus as described below (for example Ethernet interface into a PC computer system or cellular network interface into a smartphone computer system). Using any of these networks, computer system (1800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1840) of the computer system (1800).

The core (1840) can include one or more Central Processing Units (CPU) (1841), Graphics Processing Units (GPU) (1842), specialized programmable processing units in the form of Field Programmable Gate Areas (FPGA) (1843), hardware accelerators for certain tasks (1844), graphics adapters (1850), and so forth. These devices, along with Read-only memory (ROM) (1845), Random-access memory (1846), internal mass storage such as internal non-user accessible hard drives, SSDs, and the like (1847), may be connected through a system bus (1848). In some computer systems, the system bus (1848) can be accessible in the form of one or more physical plugs to enable extensions by additional CPUs, GPU, and the like. The peripheral devices can be attached either directly to the core's system bus (1848), or through a peripheral bus (1849). In an example, the screen (1810) can be connected to the graphics adapter (1850). Architectures for a peripheral bus include PCI, USB, and the like.

CPUs (1841), GPUs (1842), FPGAs (1843), and accelerators (1844) can execute certain instructions that, in combination, can make up the aforementioned computer code. That computer code can be stored in ROM (1845) or RAM (1846). Transitional data can be also be stored in RAM (1846), whereas permanent data can be stored for example, in the internal mass storage (1847). Fast storage and retrieve to any of the memory devices can be enabled through the use of cache memory, that can be closely associated with one or more CPU (1841), GPU (1842), mass storage (1847), ROM (1845), RAM (1846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1800), and specifically the core (1840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1840) that are of non-transitory nature, such as core-internal mass storage (1847) or ROM (1845). The software implementing various embodiments of the present disclosure can be stored in such devices and executed by core (1840). A computer-readable medium can include one or more memory devices or chips, according to particular needs. The software can cause the core (1840) and specifically the processors therein (including CPU, GPU, FPGA, and the like) to execute particular processes or particular parts of particular processes described herein, including defining data structures stored in RAM (1846) and modifying such data structures according to the processes defined by the software. In addition or as an alternative, the computer system can provide functionality as a result of logic hardwired or otherwise embodied in a circuit (for example: accelerator (1844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

### APPENDIX A: ACRONYMS

JEM: joint exploration model
VVC: versatile video coding
BMS: benchmark set

### MV: Motion Vector

### HEVC: High Efficiency Video Coding

### SEI: Supplementary Enhancement Information

### VUI: Video Usability Information

### GOPs: Groups of Pictures

### TUs: Transform Units,

### PUs: Prediction Units

### CTUs: Coding Tree Units

### CTBs: Coding Tree Blocks

### PBs: Prediction Blocks

### HRD: Hypothetical Reference Decoder

### SNR: Signal Noise Ratio

### CPUs: Central Processing Units

### GPUs: Graphics Processing Units

### CRT: Cathode Ray Tube

### LCD: Liquid-Crystal Display

### OLED: Organic Light-Emitting Diode

### CD: Compact Disc

### DVD: Digital Video Disc

### ROM: Read-Only Memory

### RAM: Random Access Memory

### ASIC: Application-Specific Integrated Circuit

### PLD: Programmable Logic Device

### LAN: Local Area Network

GSM: Global System for Mobile communications

### LTE: Long-Term Evolution

### CANBus: Controller Area Network Bus

### USB: Universal Serial Bus

### PCI: Peripheral Component Interconnect

### FPGA: Field Programmable Gate Areas

SSD: solid-state drive

### IC: Integrated Circuit

### CU: Coding Unit

### NIC: Neural Image Compression

### R-D: Rate-Distortion

### E2E: End to End

### ANN: Artificial Neural Network

### DNN: Deep Neural Network

### CNN: Convolution Neural Network

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for video decoding in a video decoder, comprising:
decoding at least one of a first flag or a second flag in a syntax structure for a first picture in a coded video sequence (CVS), the first picture including a first subpicture, the first flag indicating whether first subpicture partitioning information of the first picture is signaled in the syntax structure, the second flag indicating whether first subpicture scaling window information for the first subpicture is signaled in the syntax structure; and
reconstructing the first subpicture based on the at least one of the first flag indicating that the first subpicture partitioning information of the first picture is signaled in the syntax structure or the second flag indicating that the first subpicture scaling window information for the first subpicture is signaled in the syntax structure.

2. The method of claim 1, wherein the syntax structure is a first picture parameter set (PPS) syntax structure.

3. The method of claim 1, wherein
the at least one of the first flag and the second flag includes the first flag, and
the first flag indicates that the first subpicture partitioning information for the first picture is signaled in the syntax structure.

4. The method of claim 3, wherein
the first picture includes a plurality of subpictures, the plurality of subpictures including the first subpicture, and
the method further includes determining, based on the first subpicture partitioning information, a first subpicture layout of the plurality of subpictures in the first picture including a size and a position of each of the plurality of subpictures in the first picture.

5. The method of claim 4, further comprising:
determining a subpicture identifier (ID) of each subpicture in the first picture based on the first subpicture partitioning information in the syntax structure.

6. The method of claim 4, wherein
the syntax structure is a first picture parameter set (PPS) syntax structure, and
the method further includes:
decoding second subpicture partitioning information signaled in a second PPS syntax structure for a second picture in the CVS; and
reconstructing second subpictures in the second picture based on the second subpicture partitioning information, a second subpicture layout of the second picture being different from the first subpicture layout of the first picture.

7. The method of claim 1, wherein
the first picture is in a first layer in the CVS, and
the method further includes:
decoding second subpicture partitioning information signaled in another syntax structure for a second picture in a second layer in the CVS, the second subpicture partitioning information being different from the first subpicture partitioning information; and
reconstructing second subpictures in the second picture based on the second subpicture partitioning information.

8. The method of claim 1, wherein
the at least one of the first flag and the second flag includes the second flag, and
the second flag indicates that the first subpicture scaling window information of the first subpicture is signaled in the syntax structure.

9. The method of claim 8, wherein
the method further includes decoding the first subpicture scaling window information of the first subpicture based on the syntax structure; and
the reconstructing the first subpicture includes reconstructing the first subpicture using subpicture-wise reference picture resampling that is based on the first subpicture scaling window information of the first subpicture.

10. The method of claim 8, wherein
the at least one of the first flag and the second flag further includes the first flag;
the first flag indicates that the first subpicture partitioning information is signaled in the syntax structure;
the method further includes:
decoding the first subpicture scaling window information of the first subpicture based on the syntax structure; and
determining dimension information and position information of the first subpicture based on the first subpicture partitioning information; and
the reconstructing the first subpicture includes reconstructing the first subpicture based on the first subpicture scaling window information of the first subpicture, the dimension information of the first subpicture, and the position information of the first subpicture.

11. An apparatus for video decoding, comprising:
processing circuitry configured to:
decode at least one of a first flag or a second flag in a syntax structure for a first picture in a coded video sequence (CVS), the first picture including a first subpicture, the first flag indicating whether first subpicture partitioning information of the first picture is signaled in the syntax structure, the second flag indicating whether first subpicture scaling window information for the first subpicture is signaled in the syntax structure; and
reconstruct the first subpicture based on the at least one of the first flag indicating that the first subpicture partitioning information of the first picture is signaled in the syntax structure or the second flag indicating that the first subpicture scaling window information for the first subpicture is signaled in the syntax structure.

12. The apparatus of claim 11, wherein the syntax structure is a first picture parameter set (PPS) syntax structure.

13. The apparatus of claim 11, wherein
the at least one of the first flag and the second flag includes the first flag, and
the first flag indicates that the first subpicture partitioning information for the first picture is signaled in the syntax structure.

14. The apparatus of claim 13, wherein
the first picture includes a plurality of subpictures, the plurality of subpictures including the first subpicture, and
the processing circuitry is configured to determine, based on the first subpicture partitioning information, a first subpicture layout of the plurality of subpictures in the first picture including a size and a position of each of the plurality of subpictures in the first picture.

15. The apparatus of claim 14, wherein the processing circuitry is configured to:
determine a subpicture identifier (ID) of each subpicture in the first picture based on the first subpicture partitioning information in the syntax structure.

16. The apparatus of claim 14, wherein
the syntax structure is a first picture parameter set (PPS) syntax structure, and
the processing circuitry is configured to:
decode second subpicture partitioning information signaled in a second PPS syntax structure for a second picture in the CVS; and
reconstruct second subpictures in the second picture based on the second subpicture partitioning information, a second subpicture layout of the second picture being different from the first subpicture layout of the first picture.

17. The apparatus of claim 11, wherein
the first picture is in a first layer in the CVS, and
the processing circuitry is configured to:
decode second subpicture partitioning information signaled in another syntax structure for a second picture in a second layer in the CVS, the second subpicture partitioning information being different from the first subpicture partitioning information; and
reconstruct second subpictures in the second picture based on the second subpicture partitioning information.

18. The apparatus of claim 11, wherein
the at least one of the first flag and the second flag includes the second flag, and
the second flag indicates that the first subpicture scaling window information of the first subpicture is signaled in the syntax structure.

19. The apparatus of claim 18, wherein
the at least one of the first flag and the second flag further includes the first flag;
the first flag indicates that the first subpicture partitioning information is signaled in the syntax structure; and
the processing circuitry is configured to:
decode the first subpicture scaling window information of the first subpicture based on the syntax structure;
determine dimension information and position information of the first subpicture based on the first subpicture partitioning information; and
reconstruct the first subpicture based on the first subpicture scaling window information of the first subpicture, the dimension information of the first subpicture, and the position information of the first subpicture.

20. A non-transitory computer-readable storage medium storing a program executable by at least one processor to perform:
decoding at least one of a first flag or a second flag in a syntax structure for a first picture in a coded video sequence (CVS), the first picture including a first subpicture, the first flag indicating whether first subpicture partitioning information of the first picture is signaled in the syntax structure, the second flag indicating whether first subpicture scaling window information for the first subpicture is signaled in the syntax structure; and
reconstructing the first subpicture based on the at least one of the first flag indicating that the first subpicture partitioning information of the first picture is signaled in the syntax structure or the second flag indicating that the first subpicture scaling window information for the first subpicture is signaled in the syntax structure.
